(19) United States
(12) Patent Application Publication
(10) Pub. No.: US 2004/0003209 A1
(43) Pub. Date: Jan. 1, 2004

(54) Data processor

(75) Inventors: Naoki Mitsuishi, Kodaira (JP); Shinichi Shibahara, Kodaira (JP); Takahiro Okubo, Hanno (JP); Hiromi Nagayama, Akishima (JP); Takeshi Kataoka, Tokyo (JP); Masahiro Kainaga, Kokubunji (JP)

Correspondence Address: Miles & Stockbridge P.C., Suite 500, 1751 Pinnacle Drive, McLean, VA, 22102-3833, US

(73) Assignee: Hitachi Ltd.

(21) Appl. No.: 10/458,713

(22) Filed: Jun. 11, 2003

(30) Foreign Application Priority Data
Oct. 21, 2002 (JP) 2002-305308
Jun. 28, 2002 (JP) 2002-191340

(51) Int. Cl. G06F 9/34

(52) U.S. Cl. 712/225; 711/214; 711/220

(57) ABSTRACT

Disclosed here is a data processor provided with an addressing mode for calculating each effective address from the displacement (reference address) included in the subject instruction and the information retained in an index register allocated to a general-purpose register so as to minimize an increase of the logical/physical scale. The value in the index register is increased so as to be shifted according to the memory access size, for example, by one when the memory access size is byte and by two when the memory access size is word. Because both extension and shifting are included in the effective address calculation, the number of instructions, as well as the number of execution states are reduced. And, because the array size is smaller than the address space size, the upper part of each general-purpose register is used as a data register, thereby the data amount to be written in each general-purpose register is increased and the number of times for reading/writing from/in the subject memory is reduced. Consequently, the number of instructions is further reduced, thereby the program capacity is reduced.

### BACKGROUND OF THE INVENTION

The present invention relates to a data processor, which is often referred to as a microcomputer, data processor, or microprocessor. More particularly, the present invention relates to a technique employed for central processing units (CPU) effectively to improve the efficiency of programming or coding.

The microcomputer formed as a semiconductor integrated circuit has been enhanced to expand the address space and the instruction set, as well as to improve the processing speed thereof. Patent documents 1 and 2 disclose such a microcomputer capable of expanding the address space and the instruction set while keeping the compatibility among objects. According to those patent documents 1 and 2, a 32-bit general-purpose register is usable as any of a 32-bit address register and a 32-bit data register as is. Such a 32-bit general-purpose register can also be divided into two 16-bit data registers or the lower 16-bit data register can further be divided into two 8-bit registers. Patent document 3 discloses a technique for realizing a processor provided with a register used to denote the size of the address space so that the size of each built-in general-purpose register is varied according to the size set in the register. In this connection, a single-chip processor having a built-in ROM used as a program memory comes to be reduced in program capacity, since the built-in ROM is less in capacity than other memories connectable to external.

In recent years, flash memories and EEPROM memories capable of writing/reading data electrically therein/therefrom have come to be often used as single chip microcomputer ROMs. Each of those memories employs large storage elements and requires a high voltage generation circuit for enabling data to be written/deleted therein/therefrom. Consequently, the physical size of such a memory becomes large, so that the program capacity is required to be reduced much more than ever. The built-in RAM in such a memory also faces the same problem; the amount of data to be handled therein must be reduced as much as possible.

On the other hand, high-level languages such as the C language have come to be often used to describe microcomputer programs. If such a high-level language is used to describe a microcomputer program, both program and data are apt to increase in capacity more than when an assembly language is used to describe the program.

Patent documents 4 and 5 disclose addressing modes such as register indirect addressing respectively. The patent document 4 describes a data processor having an indirect addressing mode for registers with displacement. The patent document 5 describes a data processor having an indirect address specification mode for registers with displacement.

[Patent Document 1]

Japanese Unexamined Patent Publication No.Hei5(1993)-241826

[Patent Document 2]

Japanese Unexamined Patent Publication No.Hei6(1994)-519981

[Patent Document 3]

Japanese Unexamined Patent Publication No.Hei6(1994)-103063

[Patent Document 4]

Japanese Unexamined Patent Publication No.Hei4(1992)-333153

[Patent Document 5]

Japanese Unexamined Patent Publication No.Hei10(1998)-49369

### SUMMARY OF THE INVENTION

The present inventor et al have examined how to reduce both program capacity and data capacity in the following aspects.

The first aspect relates to effective address calculation for arrays, etc. There is an addressing mode referred to as the indirect addressing for registers with displacement. This mode is used as follows; data is read/written from/in an effective address generated by adding displacement included in the subject instruction code to an address retained in a general-purpose register. If this mode is used to read numbered data (ex., the n-th data) disposed in a word-size array in an area beginning at a predetermined address (TOP) in a general-purpose register (ROL), the array number is used as an address register. Thus, the numbered data is extended with zeroes so that the data is read as 32-bit data (the reading is done twice so that bits 8-16 are read by an instruction EXTU.W and bits 16-32 are read by an instruction EXTU.L). After that, the result is multiplied by 2 corresponding to the word-size data (shifted by one bit to the left by an instruction SHLL), then the instruction MOV.W is issued to access the target memory. This reading is described in the program as follows, for example.

| | |
|---|---|
| EXTU.W | R0 |
| EXTU.L | ER0 |
| SHLL.L | ER0 |
| MOV.W | @(TOP:16, ER0), E0 |

It is also possible here to add an index to the address retained in the general-purpose register.

The second aspect relates to repeating of effective address calculation. It often occurs that the same address is used by a plurality of times for accessing arrays. This repeating of effective address calculation makes the access very inefficient.

The third aspect relates to a branch instruction used, for example, for a program counter relative addressing mode. This branch instruction, when it is issued in the program counter relative addressing mode, enables branching to an effective address generated by adding displacement included in the subject instruction code to the value in the subject program counter. If there are a plurality of destination addresses specified for such branching, the branch instruction must be described for each of the destination addresses in the program counter relative addressing mode.

The fourth aspect relates to a branch instruction for memory indirect addressing. In some cases, an address is destined from a plurality of places. In this connection, the destination addresses may be stored as a table to shorten the instruction code of the branch instruction itself. There is another addressing mode referred to as the memory indirect addressing mode. In this mode, a 16-bit (2-byte) instruction code includes 8-bit address information used to refer to a branch destination address table, then this branch table is read and the read data is used for the branching. On the other hand, if a branch instruction includes a branch destination address (ex., 24 bits) in its instruction code, the instruction becomes as long as 32 bits (4 bytes). In that case, the memory indirect addressing mode should be used if there is a branch instruction that includes branches to be destined to the same address while data is stored in the branch table in units of 32 bits. However, this method is limited in both of the number of branch tables to be prepared and the table capacity and the branch tables are also used commonly for exception processing vectors, thereby the branch tables may not be used so easily.

The fifth aspect relates to an efficient use of RAMs. The efficiency of using a RAM area will be improved if one address (byte) can store a plurality of data items while each data, which is represented by 3 bits, consists of less than 8 bits. For example, in such a case, 3-bit data, 3-bit data, and 2-bit data are stored in the address sequentially from lower bits to upper bits. When those 3-bit, 3-bit, and 2-bit data items are to be described in a source program with use of the C language, the description is declared in the bit field. For example, it is defined as follows in the above example.

```
struct {
    unsigned char cc:2;
    unsigned char bb:3;
    unsigned char aa:3;
} abc
```

To operate this bit field data bb, the data bb is usually fetched into a general-purpose register. This program description will be as follows, for example.

| | |
|---|---|
| MOV. B | @abc, R0L |
| AND. B | #8′ b00111000, R0L |
| SHLR. B | #3, R0L |

In other words, data is read in bytes from the memory to a general-purpose register once, then the data in other fields than the bit field are all cleared to zeroes and data in the bit field is shifted by 3 bits to make lower padding. For an instruction set that supports only single-bit shifting, three SHLR instructions are needed.

After the operation, when data is to be stored in the memory, the following instructions must be executed.

| | |
|---|---|
| MOV. B | @abc, R1L |
| AND. B | #8′ b11000111, R1L |
| SHLL. B | #3, R0L |
| OR. B | R1L, R0L |
| MOV. B | ROL, @abc |

In other words, data is read from the memory in which the data is to be stored later, then written into a general-purpose register once. After that, the target bit field is cleared to zero. On the other hand, data to be stored is shifted so that the data is positioned in the target bit field. After that, the data items in both memory and register are ANDed and the result is stored in the memory.

While the above method can reduce the memory (RAM) capacity to be consumed with use of the bit field, such a reduction results in an increase of the program capacity. If data of less than 8 bits is handled in bytes (ex., zeroes are written in the upper part at the time of lower padding), however, the operation is simplified and the program capacity is suppressed while the method increases the memory (RAM) capacity to be consumed.

Under such circumstances, it is an object of the present invention to provide a method capable of reducing the program capacity (ROM capacity to be used).

It is another object of the present invention to provide a method capable of reducing the capacity (RAM capacity to be used) of data to be used.

It is still another object of the present invention to provide a method for minimizing the logical/physical scale of the data processor, thereby improving the processing speed of the data processor.

The above and further objects and novel features of the present invention will more fully appear from the following detailed description when the same is read in connection with the accompanying drawings.

The typical aspects of the present invention to be disclosed in this document will be described briefly as follows.

[1] [Effective Address Calculation for Arrays, etc.]

The data processor of the present invention includes instruction executing circuit for reading and decoding an instruction, then executing the instruction according to the result of the decoding. The instruction executing circuit includes a general-purpose register for retaining information in its storage area wholly or partially. The instruction executing means, when having read a first instruction that uses the storage area of a general-purpose register partially, shifts the information retained in the general-purpose register specified by the first instruction according to the access size of the information, then adds another information to the shifted information to obtain an effective address.

More concretely, for example, the data processor is provided with an addressing mode for accessing a memory (indirect addressing mode for index registers with displacement). The mode is used to access a target memory by obtaining an effective address from the address information, that is, reference address information (ex., given by the displacement included in the subject instruction) described in the subject instruction and the information set in the index register (ex., information for denoting its position disposed in the array) allocated to a general-purpose register. Then, according to the memory accessing size, the data in the memory is shifted so that the value in the index register (for retaining a value to be added to the address) is multiplied by one if the size is byte, by two if the size is word, and by four if the size is long word. The size of the index register may also be selected from 32 bits, 16 bits, and 8 bits independently. For example, if an array size is less than 256, 8 bits will be enough as the index register size. Th upper part of the general-purpose register is thus usable as an additional 8-bit data register. In other words, it is possible to calculate only the data specified by the access size among the data stored in the general-purpose register while the original information of the data stored in the upper part of the general-purpose register is retained (or kept) as is.

The first instruction that employs the indirect addressing mode for index registers with displacement is described as follows to transfer data, for example.

MOV.W EO, @(d: 16, ROL)

The CPU in this addressing mode can extend the subject general-purpose register with zeroes to shift the data therein, add the displacement to the shifted data, and use the result as an address.

In this connection, it is possible to reduce the number of instructions and the number of execution states in the CPU if both zero-extension and data shifting are included in the effective address calculation. Because the array size is smaller than the address space, the upper part of the general-purpose register is usable as an additional data register, so that the amount of data to be stored in the register increases. If the number of times for reading/writing from/in the memory is reduced, therefore, the number of instructions and the program capacity can further be reduced. And, the processing speed of the data processor is also improved more than the conventional method in which a plurality of instructions are united to access each array.

[2][MOVA Instruction Used for Effective Address Calculation for Arrays, etc.]

Furthermore, according to another desirable aspect of the present invention, the instruction executing means, when having read a third instruction that uses the storage area of a general-purpose register partially, shifts the information in the register according to the information access size and adds different information to the shifted information to obtain an effective address, then stores the obtained effective address in a different general-purpose register. In other words, the data processor is provided with an effective address move instruction (MOVA). The MOVA stores the effective address obtained as described above in a general-purpose register without accessing the memory. Because the data size is not known yet at the time of effective address calculation, a plurality of instructions are prepared to correspond to data sizes. For example, an instruction for obtaining an effective address as described above, then storing the address in a general-purpose register (ER1) is described in a program as follows.

MOVA/W @ (d: 16, ROL), ER1

In the above description, “/W” denotes a data size of an array assumed when the memory is accessed according to the effective address.

As described above, the same address is used by a plurality of times in some cases. If such an address is stored in a general-purpose register beforehand, no displacement is required for the second and subsequent accesses to the memory. The program capacity, as well as the number of execution states can thus be reduced.

Similarly to the indirect addressing mode for index registers with displacement as described above, the CPU is also provided with calculating functions for extending a general-purpose register, shifting information therein, adding different information to the shifted information, then storing the result in the general-purpose register. This instruction is substantially an operation instruction, which does not access the memory directly. Consequently, the instruction execution sequence is not complicated so much even when data to be used as an index is read from the memory. Therefore, effective address calculation by this instruction becomes common to that of the indirect addressing mode for index registers with displacement. The calculation does not increase the logical scale even when the MOVA instruction for effective address calculation for arrays, etc. is added to the instruction sequence.

(3)[PC Relative Branch Instruction]

A first instruction that employs, for example, the indirect addressing mode for index registers with displacement may also be used as this PC relative branch instruction. In other words, this branch instruction supports effective address calculation for program counter index register relative branching, which uses an index register as an 8-bit, 16-bit, or 32-bit register and multiplies the value in the index register by a predetermined number (when the instruction length is 16 bits, the register is multiplied by 2), then adds the value in the program counter (PC) to the result to obtain a branch address. If there are a plurality of destinations, the branching condition is evaluated at first. Then, a value is set in the index register according to the result of the evaluation, thereby only one branch instruction is used commonly for the branching to the plurality of destinations.

The CPU functions used to extend a general-purpose register, shift the information therein, add different information to the shifted information, then use the result as an address with respect to this addressing mode are common to those described above. The different information (PC value) to be added may be replaced with a displacement value, however.

For example, a case statement (case) in a C source program is evaluated and according to the evaluation result, an index used to calculate a branch destination address is stored in a general-purpose register, thereby the program capacity is reduced.

(4)[Branch Instruction in the Memory Indirect Addressing Mode]

In the second aspect of the present invention, the data processor includes an instruction execution means for reading and decoding an instruction, then executing the instruction according to the decoding result. The instruction execution means can unite the value in a predetermined field (vec) of the subject instruction with an offset (H′80), then shift the result by the number of bits corresponding to the information access size and add different information (a VBR value) to the shifted value to obtain an effective address. After that, the instruction execution means reads the memory according to the obtained effective address to use the read value as a branch destination address for executing this branch instruction. The above shifting is done as ×2 or ×4 corresponding to, for example, the instruction fetching size set in the program counter.

If the above offset value is decided to go over the range of the exception processing vector table according to the value in the vector register, it is possible to refer to a subroutine vector table mapped out of the above table range to branch to a subroutine. And, the branch instruction in the above memory indirect addressing mode is usable to make the instruction code shorter, thereby the program capacity is reduced even together with the branch table when many branch instructions are issued to access the same address. In addition, an offset can be added to the data in the subject instruction code (vec) according to the size of the program counter or address space to make the data double (×2) or four times (×4) so that the information such as the vector number field, etc. in the instruction code can be used effectively to specify many branch destination addresses. In addition, if a predetermined offset (ex., a fixed value H′80) is set before the data (vec) in the instruction code and the upper part of the offset is filled with the value retained in the vector base register (VBR) at the time of operation so that the data (vec) in the instruction code is not used commonly as the number of an exception processing vector area (exception processing vector table), overlapping can be prevented between an area to be specified by the data (vec) in the subject instruction code and an exception processing vector area. If a vector base register is employed at that time, re-arrangement of a program from the boot memory to the program memory (a processing to be executed first to execute a predetermined program faster in the subject memory) becomes easier.

The instruction executing means in the data processor of the present invention may also be configured so that the vector base register is replaced with a first register such as a subroutine vector table register dedicated to subroutine calling. In other words, the instruction executing means has a vector base register (VBR) usable to refer to the exception processing vector table and a first register (TBR) usable for referring to the routine vector table. The instruction executing means shifts the value (disp) in a predetermined field of the instruction by the number of bits corresponding to the information access size, adds the value in the first register (TBR) to the shifted value to obtain an address, then reads the subroutine vector table according to the obtained address and uses the read table value as a branch destination subroutine address to execute the subroutine call instruction.

When an object program is generated from a source program, the branch instruction to be issued to a destination having been accessed most frequently may be replaced with this branch instruction for optimizing the link between those programs.

As described above, the first register that points the start address table of a subroutine call is employed separately from the vector base register for exception processings to make subroutine calling according to the value in such a predetermined field as the disp (displacement) in the subject instruction code. In addition, if such a second register as the subroutine base register is employed to make a branch in an area within 64 KB from the start address specified in the second register at such a 16-bit entry address as that in the subroutine vector table, the subroutine vector table can be reduced in size. In other words, the instruction executing means is provided with a vector base register usable for referring to the exception processing vector table and first and second registers usable for branching to a subroutine so as to be allowed to shift the value in a predetermined field of the subject instruction by the number of bits corresponding to the information access size, adds the value in the first register to the shifted value to obtain an address, reads the subroutine vector table according to the obtained address, and adds the value in the second register to the read value to obtain a branch destination subroutine address to execute the subroutine call instruction.

(5)[Bit Field Instruction]

According to the third aspect of the invention, the data processor specifies a position of the bit field in the memory with immediate data (a field in which a logical value “1” of immediate data is set is assumed as the bit field) and enables data transfer between the bit field and a general-purpose register (lower padding). In other words, when the instruction is a load instruction (BFLD) used to transfer data from the memory to a general-purpose register, the data in the memory and the logical value of the immediate data are ANDed, then the result is right-shifted so that D is set for the MLB “1” of the immediate data. Then, the result is stored in the general-purpose register. When the instruction is a store instruction (BFST) used to transfer data from a general-purpose register to the memory, the value in the general-purpose register is left-shifted up to the MLB “1” of the immediate data. Then, the “1” MLB of the immediate data is determined as the shifted data in the general-purpose register and each of other logical value “0” bit data is determined as the data in the memory. After that, the data both in the register and in the memory are combined, then the result is written in the memory.

Consequently, a plurality of bit fields come to be stored in one address (one byte) storage area of the RAM, so that the RAM capacity is reduced without increasing the program capacity. In addition, the program capacity required to perform this processing is reduced. This method is thus preferable for single chip microcomputers and effective to improve the processing speed more than the conventional method that combines a plurality of instructions to use bit fields.

### BRIEF DESCRIPTION OF THE DRAWINGS

FIG. 1 is a detailed block diagram of a CPU of the present invention;

FIG. 2 is a block diagram of a single chip microcomputer of the present invention;

FIG. 3 is configurations of general-purpose registers and control registers built in the CPU shown in FIG. 1;

FIG. 4 is an illustration for describing how general-purpose registers are used;

FIG. 5 is an illustration for describing the address space of the CPU shown in FIG. 1;

FIG. 6 is an illustration for describing an effective address calculation method for a transfer/calculation instruction;

FIG. 7 is an illustration for describing another effective address calculation method for the transfer/calculation instruction;

FIG. 8 is an illustration for describing an effective address calculation method for a branch instruction;

FIG. 9 is an illustration for describing another effective address calculation method for the branch instruction;

FIG. 10 is an instruction format of a CPU machine language;

FIG. 11 an instruction format of the present invention;

FIG. 12 is an illustration for describing the data processing function of a bit field instruction;

FIG. 13 is an illustration for describing a logical description of address buffer functions;

FIG. 14 is a block diagram of a major portion of an arithmetic and logic operation unit;

FIG. 15 is an illustration for logic descriptions of a zero-extension function and a single-bit or two-bit shifting function of an input selector;

FIG. 16 is an illustration for a logic description of BFLD operation functions;

FIG. 17 is an illustration for a logic description of BFST operation functions;

FIG. 18 is an execution timing chart of the MOV. L@(d: 16, R1L), ER0 instruction;

FIG. 19 is an execution timing chart of the MOVA/L @(d: 16, R1L), ER1 instruction;

FIG. 20 is an execution timing chart of the BRA R2 instruction;

FIG. 21 is an execution timing chart of the JMP @@aa: 7 instruction;

FIG. 22 is an execution timing chart of the BFLD #xx, @aa: 16, R3H instruction;

FIG. 23 is an execution timing chart of the BFST R4L, #xx, @ER3 instruction;

FIG. 24 is a schematic block diagram of an environment for developing the CPU shown in FIG. 1;

FIG. 25 is a detailed illustration for describing an address calculation method in the extended memory indirect addressing mode;

FIG. 26 is an illustration for describing the operation of a subroutine instruction in the addressing mode shown in FIG. 25(6b); and

FIG. 27 is an illustration for describing the operation of a subroutine instruction when a dedicated subroutine base register that denotes the start address of a subroutine call group is employed.

### DETAILED DESCRIPTION OF THE PREFERRED EMBODIMENTS

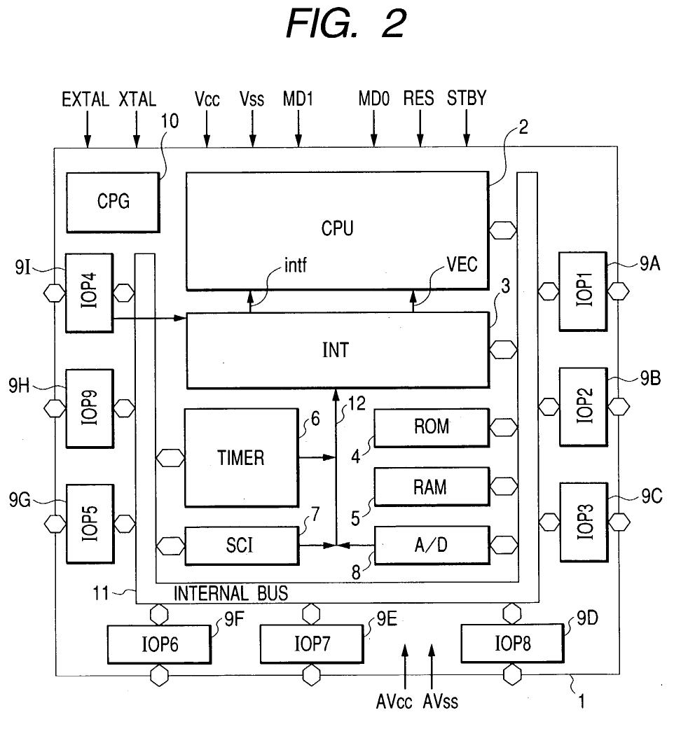

FIG. 2 shows a block diagram of a single chip microcomputer in an embodiment of the present invention.

The single chip microcomputer 1 shown in FIG. 2 is formed on one semiconductor substrate according to a known semiconductor manufacturing technique and configured by function blocks or modules such as a CPU 2 for controlling the whole operation of the microcomputer; an interruption controller (INT) 3; a ROM 4 for mainly storing programs used for processings performed in the CPU 2; a RAM 5 used as a working area of the CPU 2 and as a temporary storage of data; a timer 6; a serial communication interface (SCI) 7; an A/D converter 8; first to ninth I/O ports (IOP1 to IOP9) 9A to 9I; and a clock oscillator (CPG) 10. The ROM 4 may be any of a flash memory, an EEPROM (enabling data to be written/deleted therein/therefrom electrically), and a masked ROM.

The single chip microcomputer 1 includes power supply terminals that have a ground level (Vss), a supply voltage level (Vcc), an analog ground level (AVss), and an analog supply voltage level (AVcc), as well as other dedicated control terminals such as a reset (RES) terminal, a standby (STBY) terminal, mode control (MD0, MD1) terminals, and clock input (EXTAL, XTAL) terminals.

The single chip microcomputer 1 operates synchronously with a reference clock (system clock) generated by a crystal oscillator connected to the terminals EXTAL and XTAL of the CPG 10 or according to an external clock inputted to the EXTAL terminal. One cycle of this reference clock is referred to as a state.

The function blocks of the single chip microcomputer 1 are connected to each another through an internal bus 11. The single chip microcomputer 1 also includes a bus controller (not shown) for controlling the internal bus 11. The internal bus 11 includes an address bus, a data bus, and a control bus for transmitting bus commands encoded from read, write, and bus size signals.

The CPU 2 writes/reads data in/from the functional blocks and the modules of the single chip microcomputer 1 through the internal bus 11. The data bus of the internal bus 11 is 32 bits in width. Data can be read/written from/in the built-in ROM 4 and the RAM 5 in each state.

Control registers of the timer 6, the SCI 7, the A/D converter 8, the I/O ports (IOP1 to IOP9) 9A to 9I, and the CPG 11 are referred to nominally as an internal I/O register. Each of the I/O ports 9A to 9I is also used as an I/O terminal of corresponding one of the address bus, the data bus, and the bus control signal or the timer 6, the SCI 7, and the A/D converter 8.

The single chip microcomputer 1, when receiving a reset signal RES, is reset wholly together with its CPU 2. When the single chip microcomputer 1 is restored from this reset state, the CPU 2 reads the start address of predetermined addresses, then performs a reset exception processing to begin reading an instruction from this start address. After that, the CPU 2 reads and decodes instructions from the ROM 4 and other functional blocks and modules sequentially to process data and access the RAM 5 according to each result of this decoding.

The status of each of the timer 6, the SCI 7, an external signal, etc. can be transmitted to the CPU 2 as an interruption signal 12. The interruption signal 12 is output from the A/D converter 8, the timer 6, the SCI 7, and the I/O ports 9A to 9I and received by the interruption controller 3, which then outputs a vector VEC corresponding to the interruption request signal intf and the accepted interruption to the CPU 2 according to, for example, the specified value set in a predetermined register. If an interruption factor occurs, an interruption request is issued to the CPU 2. The CPU 2 then suspends the current processing to read the branch destination address from the address corresponding to the vector VEC in the exception processing status, then branches to a predetermined processing routine to perform the desired processing to clear the interruption factor. Usually, a return instruction is set at the end of such a predetermined processing routine. The CPU 2 performs this return instruction to restart the suspended processing.

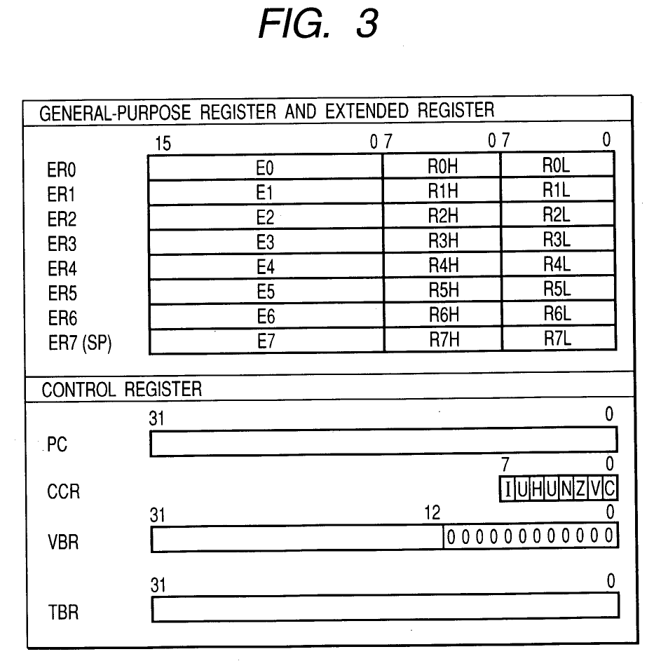

FIG. 3 shows a programming model of both general-purpose registers and control registers built in the CPU 2.

As shown in FIG. 3, the CPU 2 includes 8 general-purpose registers ER0 to ER7, each having a 32-bit length. The general-purpose registers ER0 to ER7 are all identical in function and they are also usable as address registers and data registers commonly. How to use those registers ER0 to ER7 will be described later. Among the general-purpose registers, the general-purpose register ER7 also functions as a stack pointer (SP) so as to be usable tacitly for processing exceptions and branching to subroutines. The interruption processing described above is included in exception processings.

The program counter PC is 32 bits in length and denotes the address of the next instruction to be executed by the CPU 2. Although not limited specially, the instructions to be executed by the CPU 2 are all 2 bytes (word) in length, so that the LSB in each instruction is invalid and the LSB is regarded as 0 when the instruction is read.

A condition code register CCR is an 8-bit register for denoting the internal status of the CPU 2. The 8 bits of the CCR are used for flags of the interruption mask bit (I), the half carry (H), the negative (N), the zero (Z), the overflow (V), and the carry (C).

The vector base register VBR is a 32-bit register. The lower 12 bits are all 0 and the upper 20 bits are used as the upper part of each address for reading the exception processing table and the branch destination table (subroutine vector table) in the extended memory indirect addressing mode. The subroutine vector table register (first register) TBR denotes the presence of the subroutine vector table in which entry addresses of subroutines are stored.

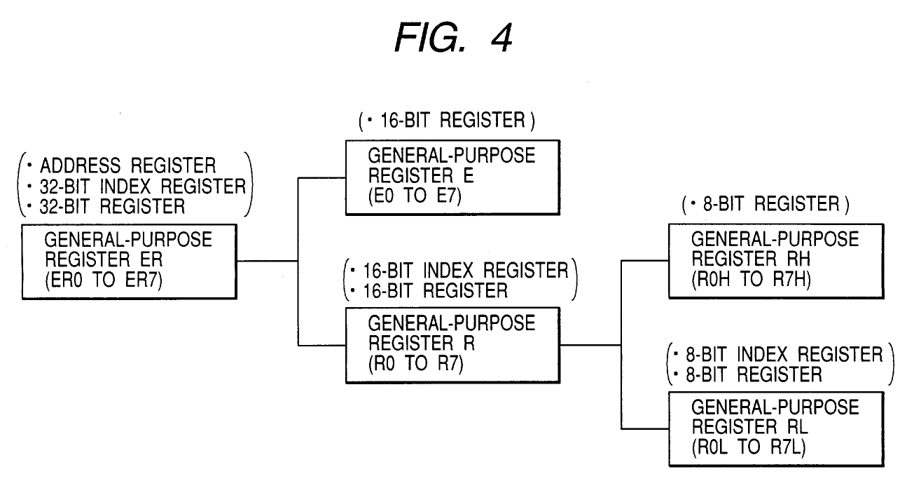

FIG. 4 shows how each general-purpose register is used. The address register and the 32-bit register are used as general-purpose registers ER (ER0 to ER7 collectively. The general-purpose registers ER (ER0 to ER7), the general-purpose registers R (R0 to R7), and the general-purpose registers RL (R0L to R7L) are used as index registers. Which of those registers is to be used as an index register is specified by the size of the corresponding index register in the subject addressing mode.

A 16-bit general-purpose register ER is divided into general-purpose registers E (E0 to E7) and general-purpose registers R (R0 to R7). Those registers E and R are identical in function. In the maximum, therefore, 16 16-bit registers are available.

An 8-bit general-purpose register R is divided into general-purpose registers RH (R0H to R7H) and general-purpose registers RL (R0L to R7L). Those registers RH and RL are all identical in function. In the maximum, therefore, 16 8-bit registers are available. How to use each general-purpose register is selectable independently.

To specify an address in a memory, a 32-bit address register is used with no shifting or a 32-bit, 16-bit, or 8-bit index register is used with no shifting, 1-bit shifting, or 2-bit shifting according to the subject data size.

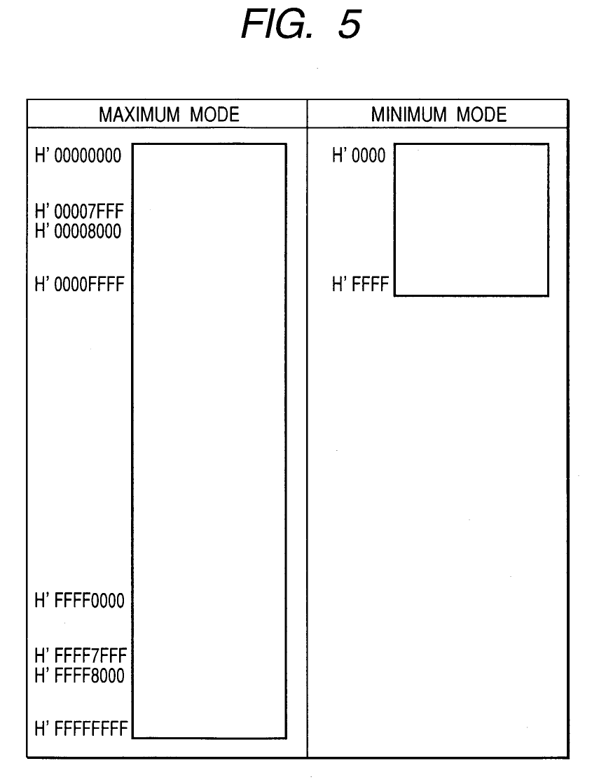

FIG. 5 shows an example of the CPU address space. The CPU 2 has a 64 KB address space in the minimum mode and a 4 GB address space in the maximum mode.

In the minimum mode, the whole address space can be specified in units of 16 bits. The exception processing vector table and the branch table (subroutine vector table) may be specified in units of 16 bits respectively.

In the maximum mode, the whole address space can be specified in units of 32 bits. The vector table and the branch table may be specified in units of 32 bits respectively. Both displacement values and 16-bit absolute addresses can be specified only between H′00000000 and H′00007FFF and between H′FFFF8000 and H′FFFFFFFF. Although not limited specially, if the built-in RAM 5 is disposed within this area, comparatively shorter displacement values and 16-bit absolute addresses can be specified in that area. The program capacity can thus be reduced.

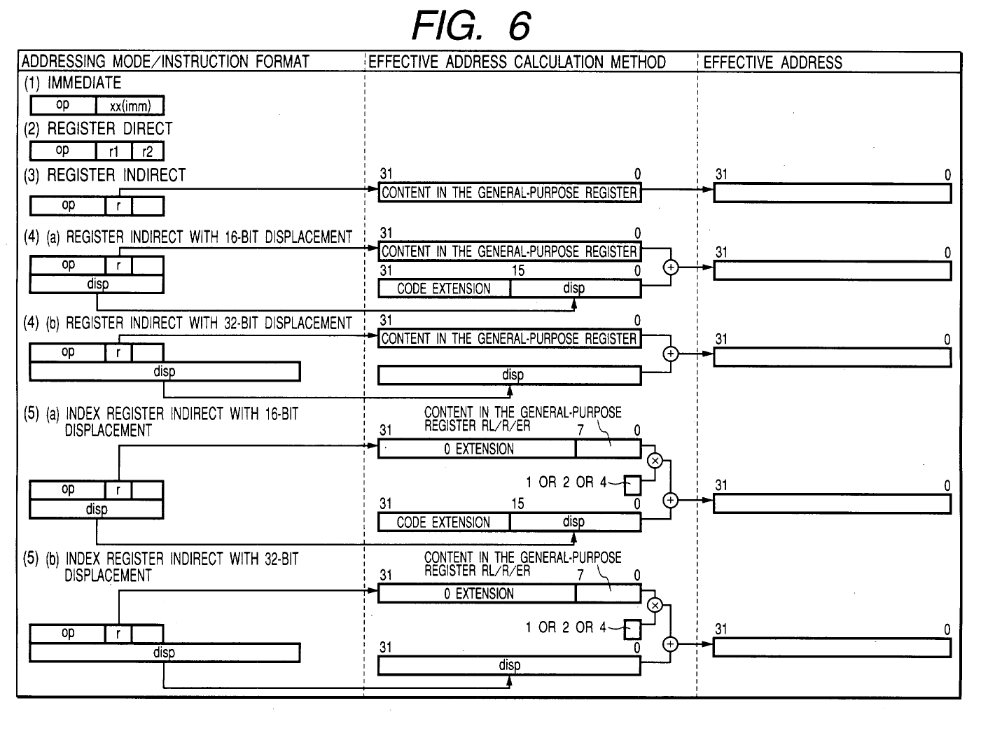

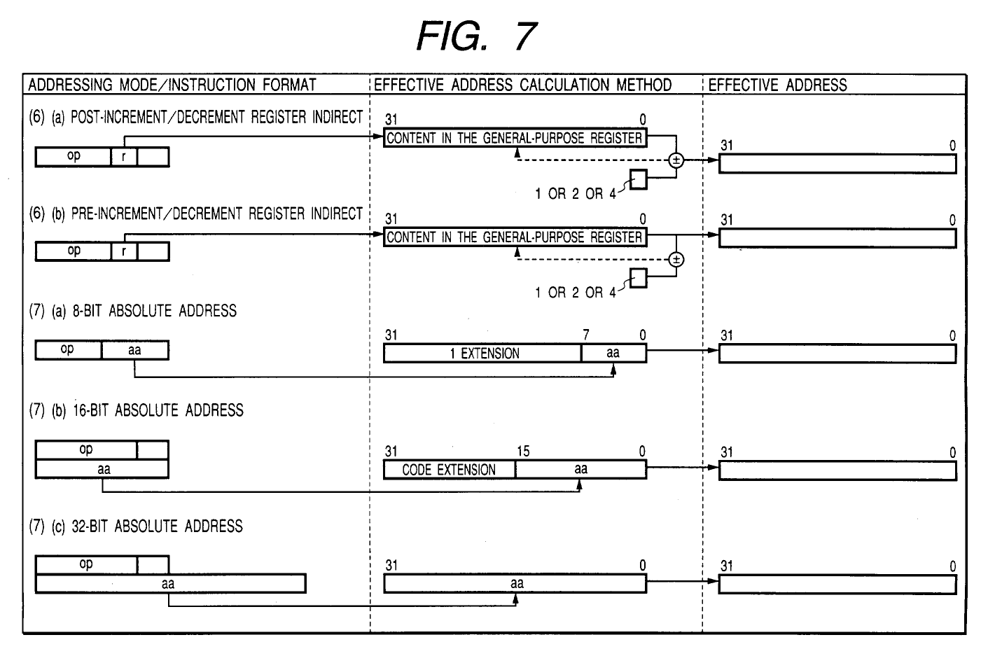

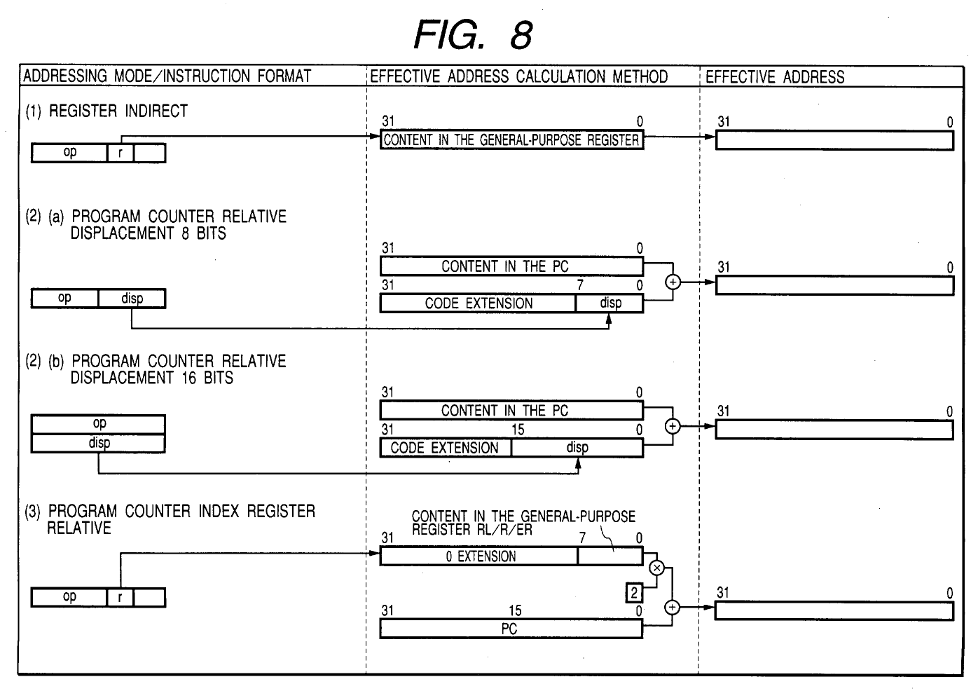

FIGS. 6 and 7 show methods for calculating effective addresses (addressing mode of each instruction) of both move and calculate instructions. FIGS. 8, 9, and 25 show methods for calculating effective addresses of the branch instruction.

(1) Register Direct [Rn]

In this addressing mode shown in FIG. 6(2), the value in the register (8-bit, 16-bit, or 32-bit) specified in the register specification field (r) of the subject instruction code functions as an operand. Registers R0H to R7H and R0L to R7L can be specified as 8-bit registers. Registers R0 to R7 and E0 to E7 can be specified as 16-bit registers. Registers ER0 to ER7 can be specified as 32-bit registers in this addressing mode respectively.

(2) Register Indirect [@ERn]

In this addressing mode shown in FIG. 6(3) and FIG. 8(1), the value in an address register (ERn) specified in the register specification field (r) of the subject instruction code is used as an address for specifying an operand in the target memory. In the advanced mode, the lower 24 bits in the branch instruction are valid while each of the upper 8 bits is regarded as 0 (H′00).

(3) Register Indirect with Displacement [@(d:2, ERn)/@(d:16, ERn)/@(d:32, ERn)]

In this addressing mode shown in FIG. 6(4)(a) and FIG. 6(4)(b), the 16-bit or 32-bit displacement (disp) included in the subject instruction code is added to the value in an address register (ERn) specified in the register specification field (r) of the instruction code and the result is used as an address for specifying an operand in the target memory. At the time of addition, the 16-bit displacement code is extended. When the data size is byte and the displacement takes a value of 1, 2, or 3, an abbreviation pattern @ (d: 2, ERn) is prepared. Similarly, when the data size is word and the displacement takes a value of 2, 4, or 6, as well as when the data size is long word and the displacement takes a value of 4, 8, or 12, an abbreviation pattern @(d:2, ERn) is prepared respectively.

(4) Index Register Indirect with Displacement [@(d:16/32, ERn.B/W/L)]

In this addressing mode shown in FIG. 6(5)(a) and FIG. 6(5)(b), the number of bits (RnL, Rn, ERn) in an address register specified in the register specification field (r) of the subject instruction code is extended with zeroes to be 32 bits, then multiplied by 1, 2, or 4 (actually shifted). After that, the 16-bit or 32-bit displacement included in the instruction code is added to the result of the multiplication, then the result is used as an address for specifying an operand in the target memory. According to the data size, the 32-bit value in the address register is multiplied by 1 when the data size is byte, 2 when the data size is word, and 4 when the data size is long word. At the time of addition, the 16-bit displacement code is extended. In other words, when the general-purpose register is used partially to retain information, the information that uses the general-purpose register partially is shifted according to the size of the information to be accessed and different information is added to the shifted information to obtain an effective address.

(5) Pre/post-increment/decrement Register Indirect [@ERn+/@−ERn/@+ERn/@ERn−]

(a) In this post-increment register indirect addressing mode [@ERn+] shown in FIG. 7(6)(a), the value in an address register (ERn) specified in the register specification field (r) of the subject instruction code is used as an address for specifying an operand in the target memory. After that, 1, 2, or 4 is added to the value in the address register according to the data size, then the result is stored in the address register. When the data size is byte, 1 is added, when the data size is word, 2 is added, and when the data size is long word, 4 is added to the value in the address register.

(b) In this pre-decrement register indirect addressing mode [@−ERn] shown in FIG. 7(6)(b), 1, 2, or 4 is subtracted from the value in an address register (ERn) specified in the register specification field (r) of the subject instruction code according to the data size, then the result is used as an address for specifying an operand in the target memory. After that, the result of the subtraction is stored in the address register. When the data size is byte, 1 is subtracted, when the data size is word, 2 is subtracted, and when the data size is long word, 4 is subtracted from the value in the address register respectively.

(c) In this pre-increment register indirect addressing mode [@+ERn] shown in FIG. 7(6)(b), 1, 2, or 4 is added to the value in an address register (ERn) specified in the register specification field (r) of the subject instruction code according to the data size and the result is used as an address for specifying an operand in the target memory. After that, the result of the addition is stored in the address register. When the data size is byte, 1 is added, when the data size is word, 2 is added, and when the data size is long word, 4 is added to the value in the address register respectively.

(d) In this post-decrement register indirect addressing mode [@ERn−] shown in FIG. 7(6)(a), the value in an address register (ERn) specified in the register specification field (r) of the subject instruction code is used as an address for specifying an operand in the target memory. After that, 1, 2, or 4 is subtracted from the value in the address register according to the data size, then the result of the subtraction is stored in the address register. When the data size is byte, 1 is subtracted, when the data size is word, 2 is subtracted, and when the data size is long word, 4 is subtracted from the value in the address register respectively.

(6) Absolute Address [@aa: 8/@aa: 16/@aa: 24/@aa: 32]

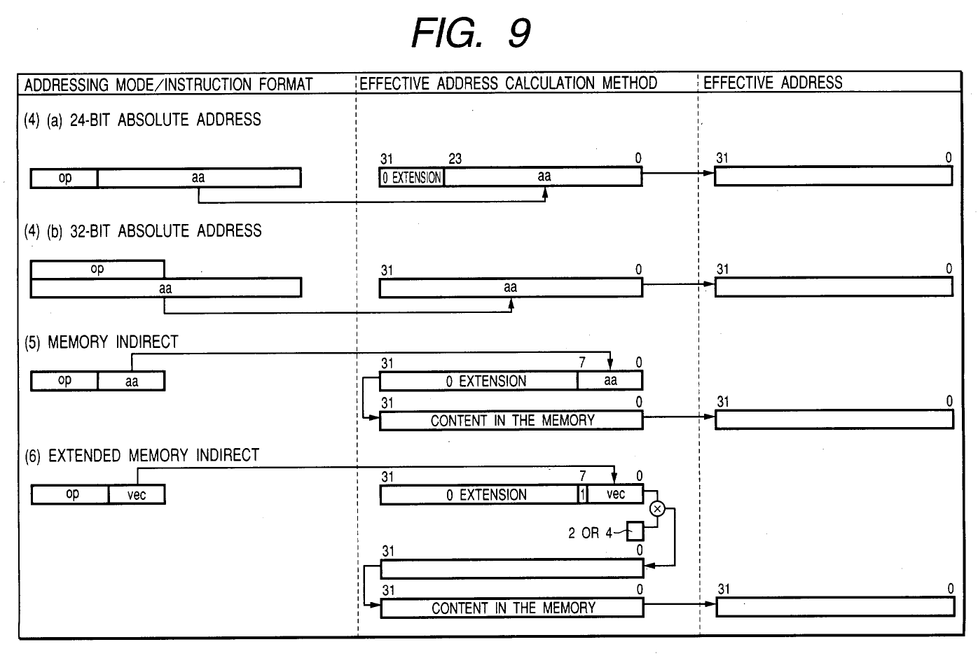

In each of these addressing modes shown in FIG. 7(7)(a), FIG. 7(7)(b), FIG. 7(7)(c), FIG. 9(4)(a), and FIG. 9(4)(b),the absolute address included in the subject instruction code is used to specify an operand in the target memory. The absolute address (aa) is 8 bits (@aa: 8), 16 bits (@aa: 16), 24 bits (@aa: 24), or 32 bits (@aa: 32) in length. The data area may be 8 bits (@aa: 8), 16 bits (@aa: 16), or 32 bits (@aa: 32) in length. For each 8-bit absolute address, the upper 24 bits in the address become all 1 (H′FFFF). For each 16-bit absolute address, the upper 16 bits are code-expanded. Each 32-bit absolute address is usable as is to access the address space. The program area may be accessed in units of 24 bits (@aa: 24) or 32 bits (@aa: 32). When the program area is accessed in units of 24 bits, the upper 8 bits become all 0 (H′00).

(7) Immediate [#xx: 8/#xx: 16/#xx: 32]

In this addressing mode shown in FIG. 6(1), the 8-bit (#xx: 8), 16-bit (#xx: 16), or 32-bit (#xx: 32) data (immediate data : imm(xx))included in the subject instruction code is used as an operand.

(8) Program Counter Relative [@(d: 8, PC)/@(d: 16, PC)]

This addressing mode shown in FIG. 8(2)(a) and FIG. 8(2)(b) is used for such instructions as the Bcc (conditional branch instruction), the BSR (subroutine branch instruction), etc. The 8-bit or 16-bit displacement included in the subject instruction code is added to a 32-bit address specified by the PC value to generate a 32-bit branch address. At the time of addition, the displacement code is extended to 32 bits in length.

(9) Program Counter Index Register Relative [@(ERn.B, PC)/@(ERn.W, PC)/@(ERn.L, PC)]

This addressing mode shown in FIG. 8(3) is used for both Bcc and BSR instructions. The number of bits (RnL, Rn, ERn) specified in an address register specified in the register specification field (r) of the subject instruction code is extended with zeros to 32 bits in length, then the result is multiplied by 2 (shifted actually). After that, the result of the multiplication is added to a 32-bit address specified by the PC (program counter) value to generate a 32-bit branch address. In other words, when the general-purpose register is used partially to retain information, the information stored in part of the general-purpose register is shifted, then the shifted information is added to the instruction address retained in the program counter (program counting circuit, pc), which is different from the shifted information, to obtain an effective address. The effective address is then used as a branch destination address.

(10) Memory Indirect [@@aa: 8]

This addressing mode shown in FIG. 9(5) is used for JMP (unconditional branch to specified address), JSR (subroutine branch to specified address), and other instructions. The 8-bit absolute address included in the subject instruction code is used to specify an operand in the target memory and the value is used as a branch destination address. The upper bits in each 8-bit absolute address is specified by the vector base register VBR. In the minimum mode, each operand in the memory is specified in the word size to generate a 16-bit branch address. In the maximum mode, the operand in the memory is specified in the long word size.

(11) Extended Memory Indirect [@@vec: 7]

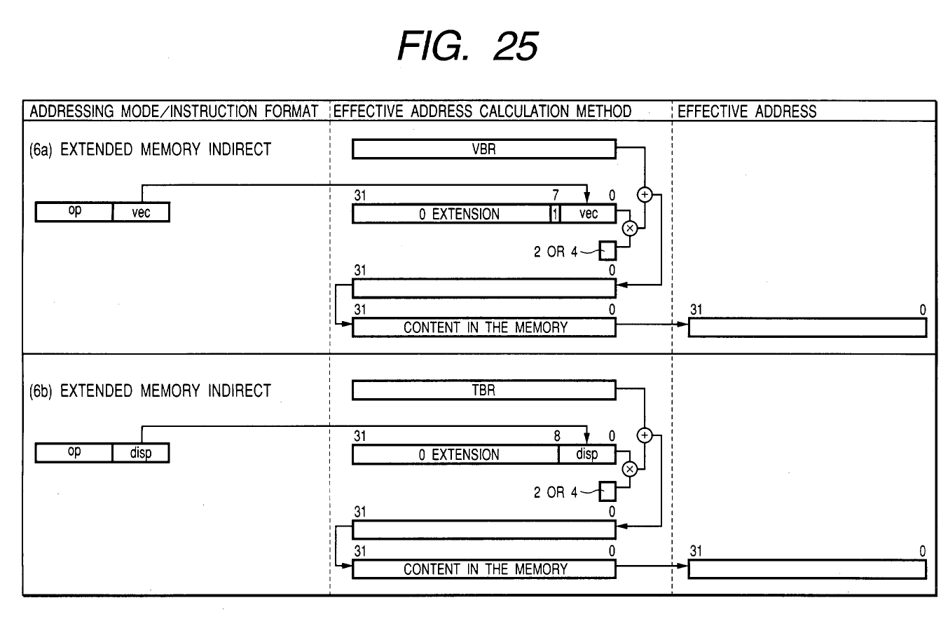

In this addressing mode shown in FIG. 9(6) and FIG. 25(a), an offset, for example, a fixed value H′80, is combined with 7-bit data (vec) included in the subject instruction code, then the result is shifted by ×2 (double) or ×4 (four times) corresponding to the value in the program counter or the size of the address space. After that, the start address of the branch table specified by such a register as the vector base register VBR is added to the shifted value to obtain an address for reading the branch table, then the read value is used as a branch destination address. Consequently, the subroutine vector table mapped over the range is allowed to be referred to so as to branch to a subroutine, because the offset value is already determined so as to go over the range of the exception processing vector table (that is, a fixed value H′80 is added to the upper part of the vec) according to the value in the vector base register VBR.

FIG. 9(6) shows no processing for the addition of the value in the vector base register VBR. However, the processing for the addition is shown in detail in (6a) of FIG. 25.

(6b) of FIG. 25 shows an illustration for describing the extended memory indirect addressing mode for enabling subroutine calls with use of the subroutine vector table register TBR dedicated to subroutine calls instead of the vector base register VBR. In other words, the value disp in a predetermined field of the subject instruction is shifted by the number of bits corresponding to the information access size, for example, 2 bits or 4 bits, then the value in the subroutine vector table register TBR is added to the shifted value to obtain an address. After that, the subroutine vector table is read according to the obtained address and the read value is used as a branch destination subroutine address. Although not shown here specially, it is possible in (6a) of FIG. 25 to add another addressing mode so as to use the TBR value instead of the VBR.

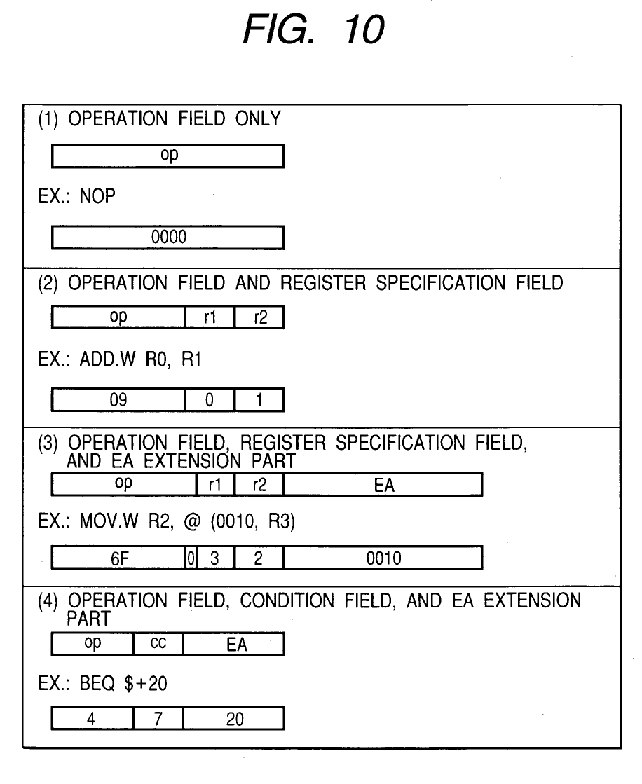

The subroutine call instruction is one of the instructions issued in the instruction format shown in (6b) of FIG. 25. The subroutine call instruction is 16 bits in length while the disp instruction is 8 bits in length. FIG. 10 shows an instruction format of the CPU machine language. CPU instructions are handled in units of 2 bytes (word). Each CPU instruction includes an operation field (op), a register specification field (r), an EA expansion part (EA), and a condition field (cc).

The operation field (op) denotes the function of the instruction and specifies the content of the operand processing for specifying an addressing mode shown in FIG. 10(1). This operation field (op) always includes the first four bits of the instruction. Some instructions have two operation fields respectively.

The register specification field (r) specifies a general-purpose register shown in FIG. 10(2). The register specification field (r) uses 3 bits for specifying an address register or 32-bit data register and 4 bits for specifying an 8-bit or 16-bit data register. Some instructions have two register specification fields (r) or no register specification field (r) respectively.

The EA extension part (EA) specifies items of immediate data, absolute address, or displacement shown in FIG. 10(3) and FIG. 10(4). This EA is an 8-bit, 16-bit, or 32-bit field. The condition field (cc) specifies a branching condition of a conditional branch instruction (Bcc instruction).

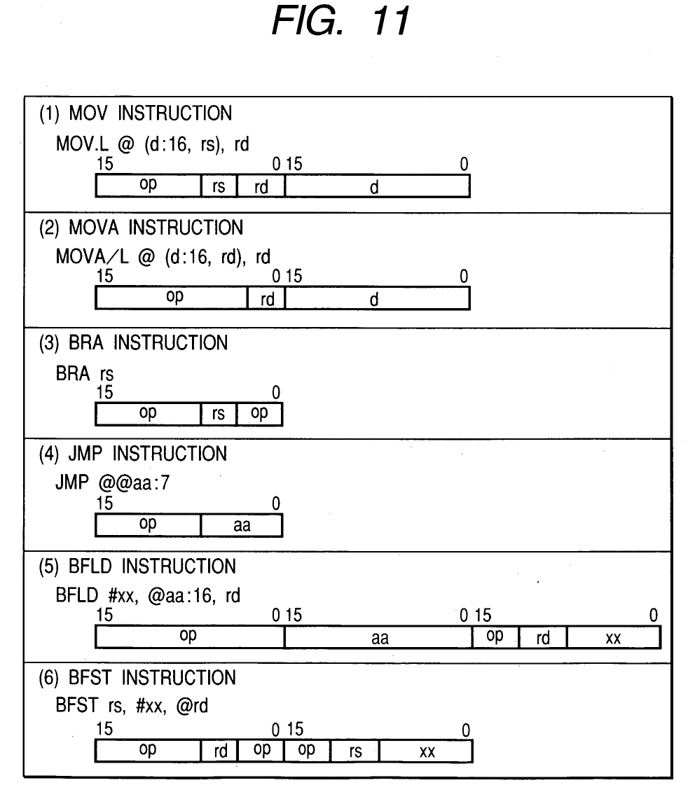

FIG. 11 shows instruction formats of the present invention.

[Effective Address Calculation for Arrays, etc.]

“MOV. L @ (d: 16, rs), rd” is a two-word instruction shown in FIG. 11(1). The bits 6-4 of the first word are used to specify an index register (rs) and the bits 3-0 are used to specify a data register (rd), the second word denotes displacement (d). This instruction is used for the indirect addressing mode for index registers with 16-bit displacement shown in (5)(a) of FIG. 6. This instruction is one of the first instructions. The move instruction, etc. used for the indirect addressing mode for registers with displacement shown in (4)(a) and (4)(b) of FIG. 6 are included in the second instructions.

8 MOVA Instruction for Effective Address Calculation for Arrays, etc.]

“MOVA/L @ (d: 16, rd), rd” is a two-word instruction shown in FIG. 11(2). The bits 2-0 of the first word are used to specify a general-purpose register (rd) that is used commonly as an index register and a data register. The second word denotes the displacement (d). This instruction is also used for the indirect addressing mode for index registers with 16-bit displacement shown in (5)(a) of FIG. 6. This instruction is one of the third instructions.

[Branch Instruction 1]

“BRA rs” is a one-word instruction shown in FIG. 11(3). The bits 6-4 are used to specify an index register (rs). This instruction is used for the program counter index register relative addressing mode shown in (3) of FIG. 8. This branch instruction is also one of the first instructions.

[Branch Instruction 2]

“JMP @@aa: 7” is a one-word instruction shown in FIG. 11(4). The bits 7-0 include address information (aa) for specifying a branch table. This instruction is used for the extended memory indirect addressing mode shown in (6) of FIG. 9 and (6a) of FIG. 25.

[Branch Instruction 3]

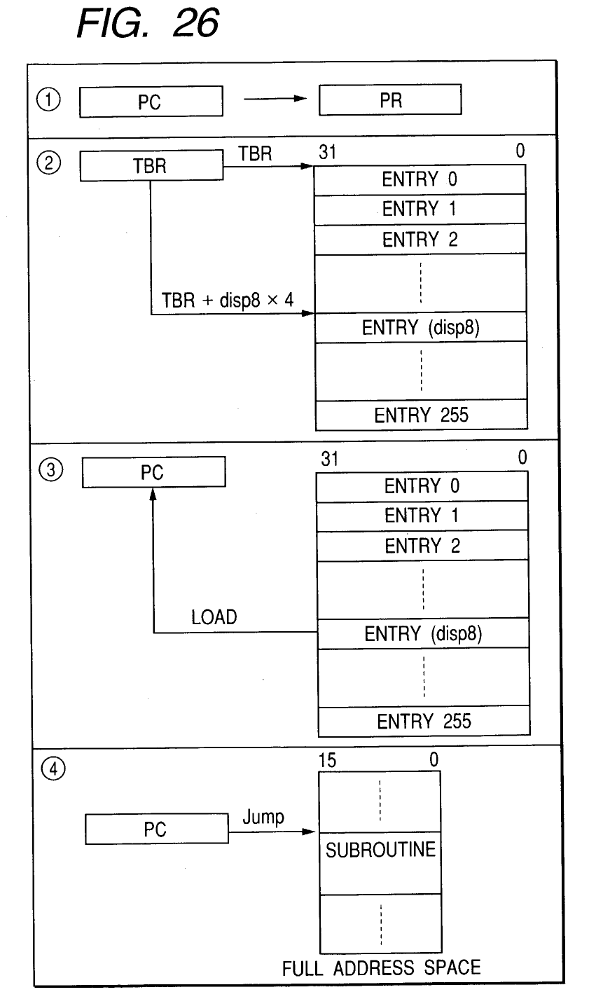

FIG. 26 shows the operation of a subroutine instruction in the addressing mode shown in (6b) of FIG. 25. The format of the 16-bit subroutine call instruction described here is “JSR/N @@ (disp8, TBR)”. The “disp8” denotes 8-bit disp (displacement). The instruction code becomes “10000011dddddddd”. The “dddddddd” denotes 8-bit disp (displacement). Roughly, the operation becomes as follows. (1) The program counter PC is saved in the PR (procedure register) so as to return. (2) The TBR (subroutine vector table register) value and the disp8×4 (left-shifted by 2 bits) value are added up to generate a 32-bit table entry address. (3) The 32-bit address is loaded from the table entry of the address generated in (2) to the program counter PC. (4) Control jumps to the address (that covers the whole space) loaded in (3).

[Branch Instruction 4]

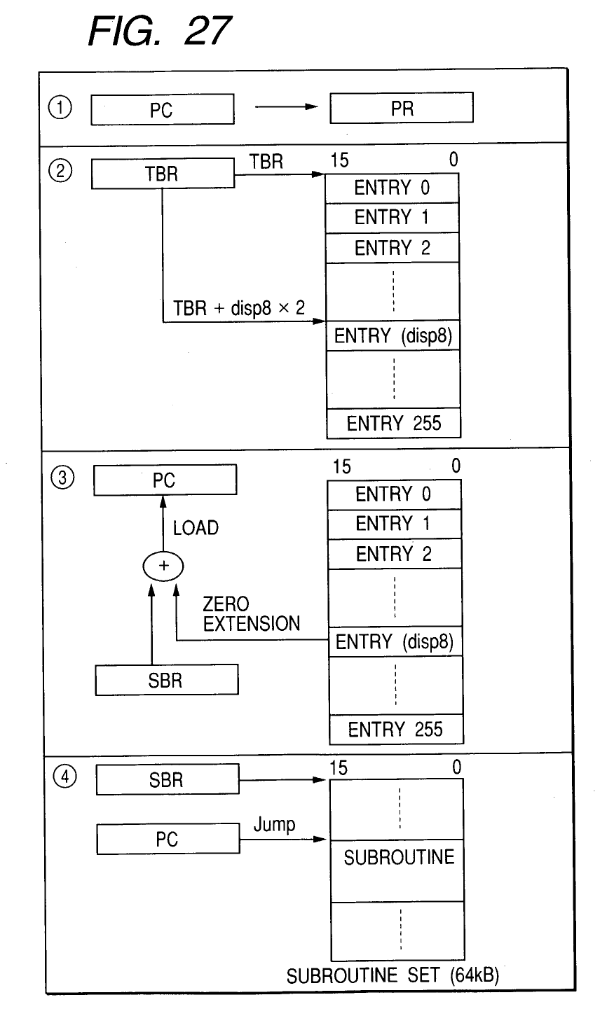

FIG. 27 shows an example of this instruction for optimizing a table size. To optimize a table size, a dedicated subroutine base register SBR that denotes the start address of a subroutine call group is further used to set instructions together, each used for branching at a 16-bit table address within an area of 64 KB from the SBR. The operation of this instruction will become as follows. (1) The value of the program counter PC is saved in the PR (procedure register) as a return address. (2) The TBR (subroutine vector table register) value and the disp8×2 value are added up so as to generate a 32-bit table entry address. (3) A 16-bit address is loaded from the address table entry generated in (2) to the program counter PC, then extended with zeroes and the SBR (subroutine base address register) value is added to the result to generate an address. (4) Control jumps to the address (that covers 64 KB) generated in (3).

As described above, a dedicated subroutine vector table register TBR for pointing the subroutine call start address table is used separately from the exception processing vector base register VBR to reduce the subroutine vector table in size. For the above branch instruction 3, the subroutine vector table can be reduced in size if a 32-bit address table can be referred to with only one 16-bit instruction due to the disp (displacement) in the subject instruction code to make a subroutine call and a subroutine base register SBR is further used just like the above branch instruction 4 to enable branching at a 16-bit table address within an area of 64 KB from the SBR.

According to the above branch instructions 3 and 4, each instruction has a code of 16 bits in length, as well as a dedicated address table to be disposed freely. Each of the instructions is allowed to jump to a given address. Consequently, the coding efficiency is improved with no restriction applied to the subroutine disposed address and the address table area. In other words, the above branch instructions 3 and 4 can satisfy all of the following requirements. 1) Coding efficiency (size reduction) 2) Correspondence to all the addresses within a range in which jumping is allowed 3) Easiness to make programming with use of a dedicated subroutine vector table area to be disposed freely

[Bit Field Instruction]

“BFLD #xx, @aa: 16, rd” is a three-word instruction shown in FIG. 11(5). The second word denotes an absolute address (aa) and the bits 7-0 of the third word include immediate data (xx), and the bits 11-8 of the third word are used to specify a destination register (rd).

“BFST rs, #xx, @rd” is a two-word instruction shown in FIG. 11(6). The bits 7-0 of the second word include immediate data (xx) and the bits 6-4 of the first word are used to specify an address register (rd) and the bits 11-8 of the second word are used to specify a source register (rs).

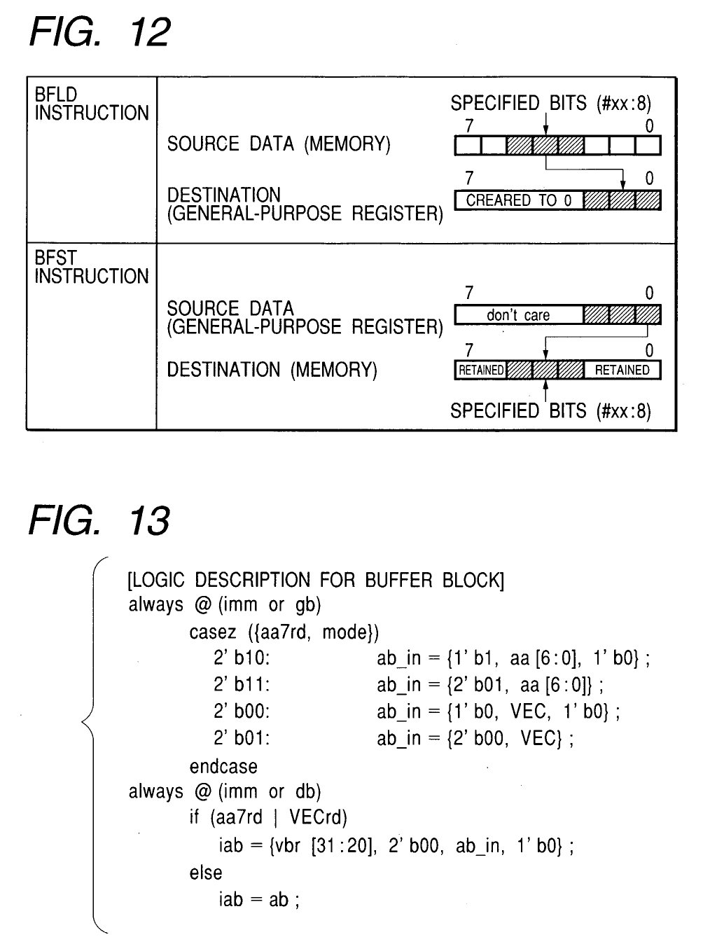

FIG. 12 shows an illustration for describing the data processing functions of each bit field instruction.

The BFLD (bit field load) instruction transfers lower-padded data in a field (hatching field) specified in the source operand to the 8-bit register Rd (0 is set in every upper bit). The bit field is specified by a “1” bit of the 8-bit immediate data (mask data). In other words, the BFLD instruction reads data from the memory to AND the read data and the immediate data included in the instruction code, then shifts the result to the right so that the logical value lower “1” bit of the immediate data becomes the MLB. The shifted data is then stored in a general-purpose register.

The BFST (bit field store) instruction transfers the value (lower-padded) set in an 8-bit register Rs to a field (hatching field) specified by the immediate data in the destination operand. The bit field is specified by a “1” bit of the 8-bit immediate data. In other words, the BFST instruction left-shifts the value set in a general-purpose register up to the logical value lower “1” bit of the immediate data included in the instruction code. The logical value “1” bit in the immediate data selects the shifted data while the logical value “0” bit selects the data read from the memory. The instruction then stores the selected data in the memory.

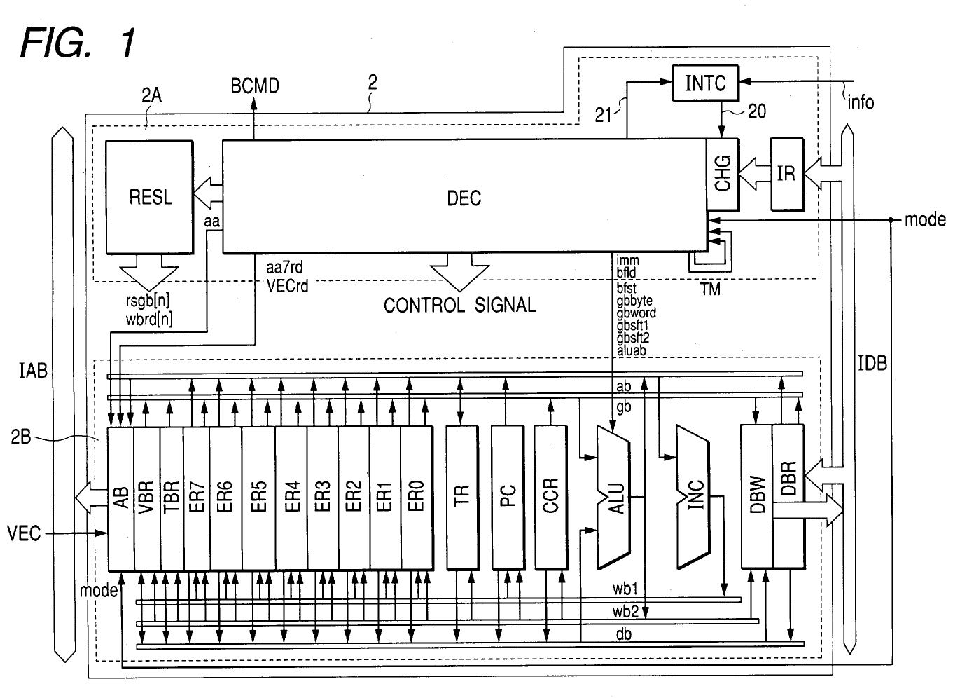

FIG. 1 shows a detailed block diagram of the CPU 2. The CPU 2, which functions as instruction executing circuit, is roughly configured by a control block 2A and an execution block 2B.

The control block 2A includes an instruction register IR, an instruction change block CHG, an instruction decoder DEC, a register selector RESL, and an interruption control block INTC.

The instruction decoder DEC is configured by, for example, a micro ROM or PLA (Programmable Logic Array) or a wiring logic. Part of the output of the instruction decoder DEC is fed back to itself. The fed-back data includes a stage code (TMG) used for the transition in the subject instruction code.

The instruction decoder DEC controls the execution block 2B. Control signals gbbyte, gbword, gbsft1, gbsft2, bfld, bfsft, aluab to be described later are output for controlling the arithmetic and logical operation unit ALU. Other control signals aa, aa7rd, and vecrd are output for controlling the memory address buffer AB.

The register selector RESL outputs register selection signals rsgb[n], wbrd[n], etc. according to the command from the instruction decoder DEC and the information of the register specification field (r) included in the subject instruction code to control the input/output of each general-purpose register. The [n] denotes one of the numbers 0 to 7 corresponding to a general-purpose register.

The instruction register IR stores a read instruction temporarily. The IR outputs each instruction to be executed to the instruction decoder DEC. The instruction change block CHG transfers instruction codes except for those of read instructions to the instruction decoder DEC. In other cases, the CHG outputs the value read from the instruction register IR to the instruction decoder DEC. Instruction codes other than those of read instructions are used, for example, to process such exceptions as interruptions under the control of the interruption control block INTC. The INTC receives an interruption request signal intf from the interruption controller 3 shown in FIG. 2 and refers to the interruption mask signal 21 output from the instruction decoder DEC. If the interruption is not masked, the INTC instructs the instruction change block CHG with a signal 20 to issue an interruption.

The execution block (EXEC) 2B includes general-purpose registers ER0 to ER7, a program counter PC, a condition code register CCR, a temporary register TR, an arithmetic and logic unit ALU, an incremental meter INC, a read data buffer DBR, a write data buffer DBW, an address buffer AB, and vector base registers VBR and TBR. Those circuit blocks are connected to each another through internal buses ab, gb, db, wb1, and wb2.

The arithmetic and logic unit ALU is used for various operations specified by instructions, as well as for calculating effective addresses. The incremental meter INC is used mainly to increase the value in the program counter PC.

Circuit blocks other than the general-purpose registers ER0 to ER7, the program counter PC, and the condition code register CCR are not referred to in programming; they are used only for the operations performed in the microcomputer 1. In other words, the read data buffer DBR, the write data buffer DBW, the address buffer AB, etc. are used to latch or buffer data temporarily to be interfaced with the internal buses IAB and IDB. The temporary register TR is used for the operation in the microcomputer 1 as needed. The internal buses IAB and IDB are an internal address bus and an internal data bus included in the internal bus 11.

The read data buffer DBR stores instruction codes (EA extended block) and data read from the ROM 4, RAM 5, internal I/O register or external memory (not shown) temporarily. The write data buffer DBW stores data to be written in the ROM 4, the RAM 5, the I/O register, or an external memory temporarily. The address buffer AB buffers addresses to be read/written by the CPU 2 and generates addresses for reading data from the exception processing vector table (vector table) and the subroutine vector table (branch table). The address buffer AB receives inputs of the vector inputted from the interruption controller, the value vec included in the subject instruction code, the value of the internal bus ab, etc. and outputs addresses. As described above, the value of the vector base register VBR is used as an upper address for referring to each table that uses the exception processing vector VEC and each table that uses the vector field value vec in the extended memory indirect addressing mode.

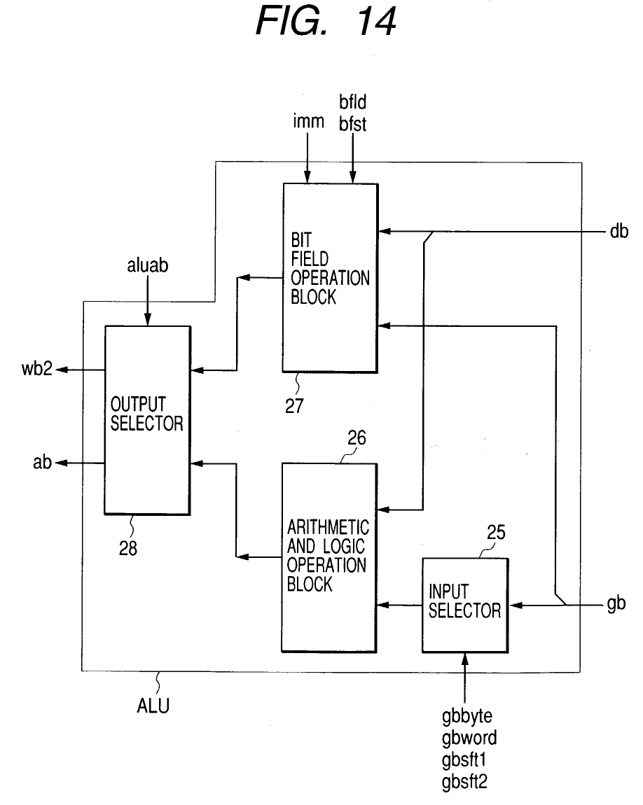

The logic for each function of the address buffer AB can be described as shown in FIG. 13. The logic description in FIG. 13 is referred to as the RTL (Register Transfer Level) or HDL (Hardware Description Language) description. The logic can be developed into a logic circuit with use of a known logic synthesizing tool. The HDL is standardized as IEEE1364. The logic description syntax shown in FIG. 13 is based on the case statement. This means that the subsequent lines are described when the value or signal defined in the ( ) following the “always@” changes. The symbol “|” denotes a logical sum and the “&” denotes a logical product. The “2′b01” denotes a 2-bit binary code 01. In the logic description in FIG. 13, the maximum mode is set at mode=0 and the minimum mode is set at mode=1. The control signal “aa7rd” is activated for reading the branch table in the extended memory indirect addressing mode and the control signal “VECrd” is activated for reading an exception processing vector. In other words, the logic description shown in FIG. 13 selects an object according to the mode signal, as well as the control signals aa7rd and VECrd. If both control signals aa7rd and VECrd are inactive, the value of the internal bus ab is selected.

FIG. 14 shows a block diagram of a major portion of the arithmetic and logic operation unit ALU. The ALU includes an input selector 25, an arithmetic and logic operation block 26, a bit field operation block 27, and an output selector 28. Although the ALU also includes some other additional function blocks such as an ALU input selector on the internal bus side db, a bit operation instruction circuit, etc. (not shown), the description for them will be omitted here.

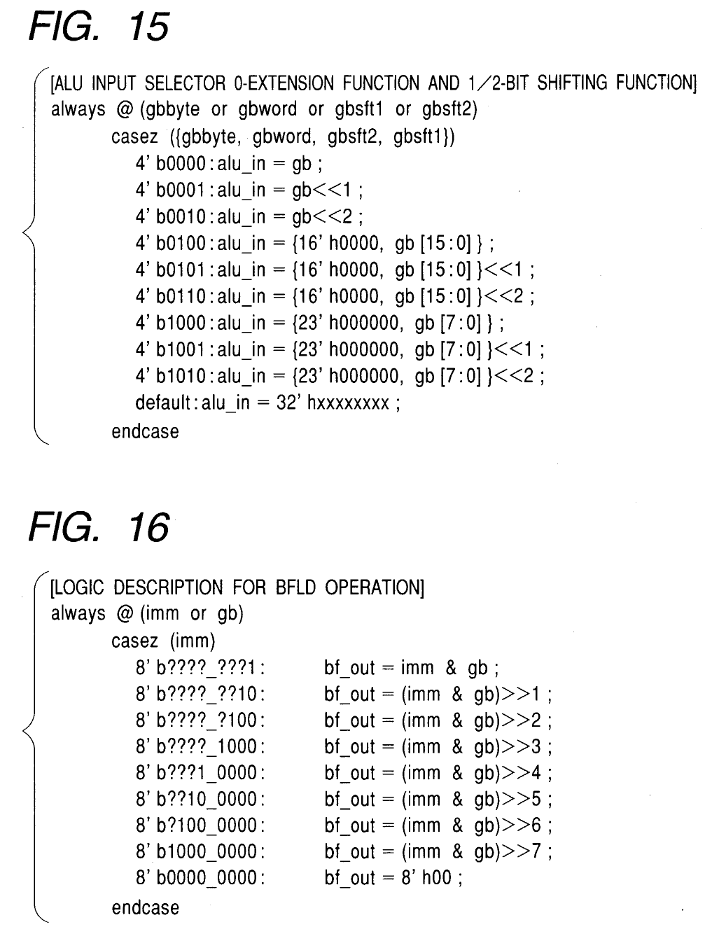

The input selector 25 has functions for zero-extension and 1-bit or 2-bit shifting. FIG. 15 shows a logic description of the functions. Concretely, a resource such as a general-purpose register to which data is to be output is selected and data is inputted to the arithmetic and logic operation unit ALU through the internal bus gb, then the size of the target general-purpose register (index register) is specified with a signal gbbyte or gbword and the upper part of the register is extended with zeros. After that, the number of bits for shifting is specified with a signal gbsft1/gbsft2 to select ×1/×2/×4. For example, for the address calculation of MOV. L @(d: 16, R1L), ER0 to be described later, gbbyte=1, gbword=0, gbsft1=0, and gbsft2=1 are set. The zero-expanded and shifted data is output from the read data buffer DBR to be added to the displacement inputted to the arithmetic and logic operation block 26 through the internal bus db. The addition result is output as an address through the output selector 28 and the internal bus ab. It is also stored in a general-purpose register through the internal bus wb2 and output to the buses ab and wb2. The input selector 25 may also have a reversal logic to subtract the value of the internal bus gb. The delay time of the index register can be reduced by avoiding the use of negative values and paralleling the logic of the input selector 25.

The bit field load operation block 27 receives signals from the internal buses gb and db, as well as immediate data (imm) and outputs operation results to the internal bus wb2. The immediate data (imm), as described above, may be bits 7-0 of the subject instruction code (xx in the BFLD instruction shown in FIG. 8). Each operation result output to the internal bus wb2 is stored in a general-purpose register or write data buffer DBW. FIG. 16 shows a logic description for this BFLD operation. In other words, the immediate data (imm) and the data from the internal bus gb are ANDed, then the result is right-shifted by the number of bits specified in the immediate data (imm) (until the MLB is changed from “1” to “0”).

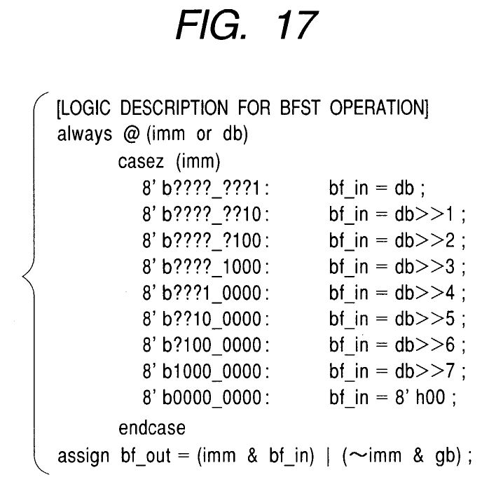

FIG. 17 shows a logic description of the BFST operation. In other words, the data from the internal bus db is left-shifted by the number of bits specified in the immediate data (imm) (up to the position of the “1” MLB) to generate “bf_in”. While each “1” bit of immediate data generates “bf_in”, other bits of the immediate data generate data of the internal bus gb (data read from the memory).

Next, each instruction execution timing of the present invention will be described. As described above, the internal bus is 32 bits in width. In this case, however, it is assumed that each instruction is read in units of 16 bits to simplify the description. It is also assumed that data is read/written from/in the built-in ROM 4 and the RAM 5 in each state respectively.

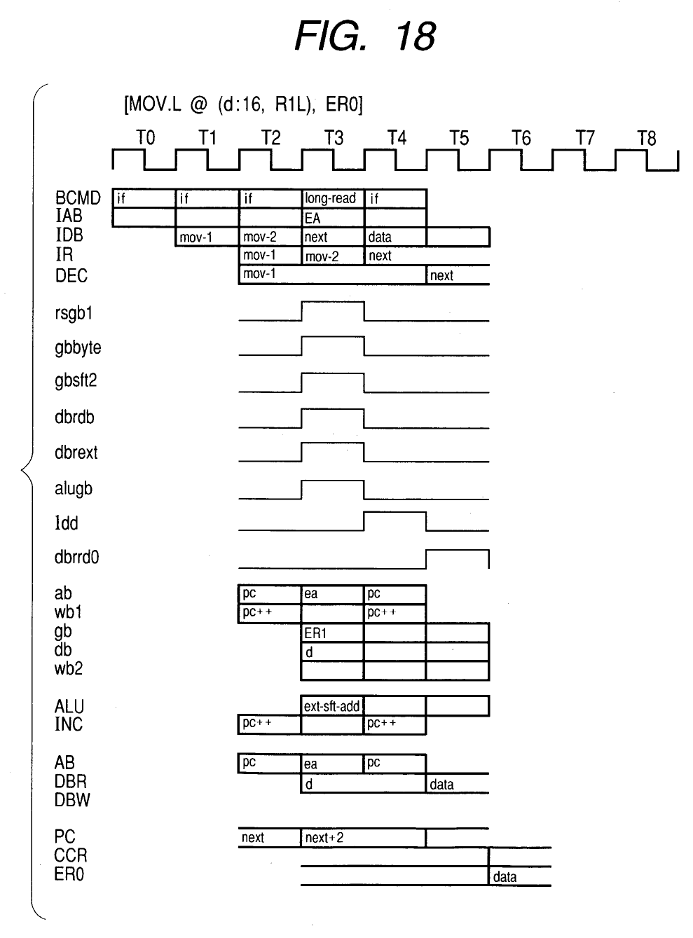

FIG. 18 shows an execution timing of the MOV. L @(d: 16, R1L), ER0 instruction. This execution timing is for each instruction corresponding to the instruction format shown in FIG. 11 [effective address calculation for arrays, etc.].

At T0, an address is output from the address buffer AB of the CPU 2 to the address bus IAB. The instruction decoder DEC then outputs a bus command BCMD, which denotes instruction fetch (if).

At T1, read data is output to the internal data bus IDB according to the address output to the internal address bus IAB at T0 and the bus command BCMD. This read data is stored in the instruction register IR at T2. The above operations are all done according to the last executed instruction.

Although not limited specially, addresses are output to the internal address bus IAB at T1, T2, T4, and T5 according to each of those addresses, then the bus command BCMD is output to the same bus to read an instruction (pre-reading). The displacement of this instruction is output to the internal data bus IDB at T2 and stored in the read data buffer DBR at T3.

When the previous instruction execution ends, the next instruction execution starts at T2 in the earliest case, then the read data and the subject instruction code are inputted to the instruction decoder DEC and decoded there.

Part (register specification field (r)) of the instruction code is inputted to the register selector RESL and decoded there. Then, according to the decoded result, a control signal/register selection signal is output at T3. After that, the signal rsgb1 is activated, thereby the value of the general-purpose register ER1 is output to the internal bus gb. On the other hand, the control signal dbrdb (not shown)(output from the read data buffer DBR to the bus db), as well as the control signal dbrext (not shown)(for specifying code extension for the data in the read data buffer DBR) are activated, thereby the code of the 16-bit displacement stored in the read data buffer DBR is extended, then output to the internal bus db. The result is then inputted to the arithmetic and logic operation unit ALU. The signals gbbyte (byte input indication signal from the internal bus gb) and gbsft2 (2-bit shift indication signal to an input from the internal bus gb) are activated, thereby the lower 8 bits of the data inputted from the internal bus gb are extended with zeros, then shifted by two bits and added to the data inputted from the internal bus db. After that, the signal aluab (indication signal for outputting the operation result of the ALU to the bus ab) is activated, thereby the addition result (ea) is output to the internal bus ab, then output to the internal address bus IAB through the address buffer AB. At the same time, a bus command BCMD that denotes the long word reading is output to the same bus IAB. At this time, data read control signals including a register selection signal are generated to control the timings of T4 and T5 sequentially. Concretely, the signal ldd (load signal issued from IDB to DBR) is activated at T4 so as to indicate controlling of the input to the read data buffer DBR. At T5, the signal dbrrd0 (DBR read signal) is activated so as to indicate transfer of the data in the read data buffer DBR to the general-purpose register ER0, which is a destination register.

The read data is output to the internal data bus IDB at T4, then inputted to the read data buffer DBR at T5 as described above. The read data is then transferred to the general-purpose register ER0 at T6. At this time, a predetermined flag of the condition code register CCR is updated according to the transferred data content.

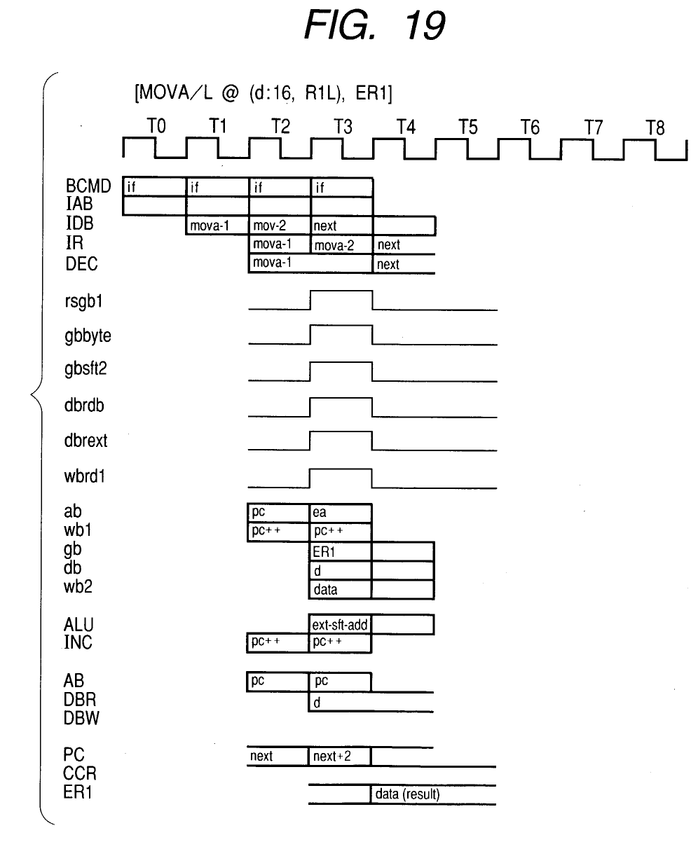

FIG. 19 shows an execution timing of the MOVA/L @(d: 16, R1L), ER1 instruction. This execution timing is for each instruction having the instruction format of [MOVA instruction for effective address calculation for arrays, etc.] shown in FIG. 11.

Similarly to the above case, the instruction code is inputted to the instruction decoder DEC at T2 so that the instruction is decoded there. The displacement of the instruction is inputted to the read data buffer DBR at T3. Part (register specification field (r)) of the instruction code is output to the register selector RESL and decoded there. According to the decoding result, a control signal/register selection signal is output at T3. Then, the signal rsgb1 (output indication signal for an output from ER1 to the bus gb) is activated, thereby the value of the general-purpose register ER1 is output to the internal bus gb. In addition, the signal dbrdb (output indication signal for an output from DBR to the bus db) is activated to output the displacement stored in the DBR to the internal bus db. All those items are inputted to the arithmetic and logic operation unit ALU. After that, the signal gbbyte and gbsft2 are activated to extend the lower 8 bits of the data inputted from the internal bus gb with zeroes, then shifts the result by two bits and added to the data inputted from the internal bus db. The result is then output to the internal bus wb2. At this time, the signal wbrd1 (write indication signal for writing data from the bus wb2 to the register ER1) is already activated, so that the data of the internal bus wb2 is stored in the general-purpose register ER1, which is a destination register. Although not limited specially, when the instruction is a MOVA, which is an instruction for transferring an effective address, the value in the condition code register CCR is kept as is.

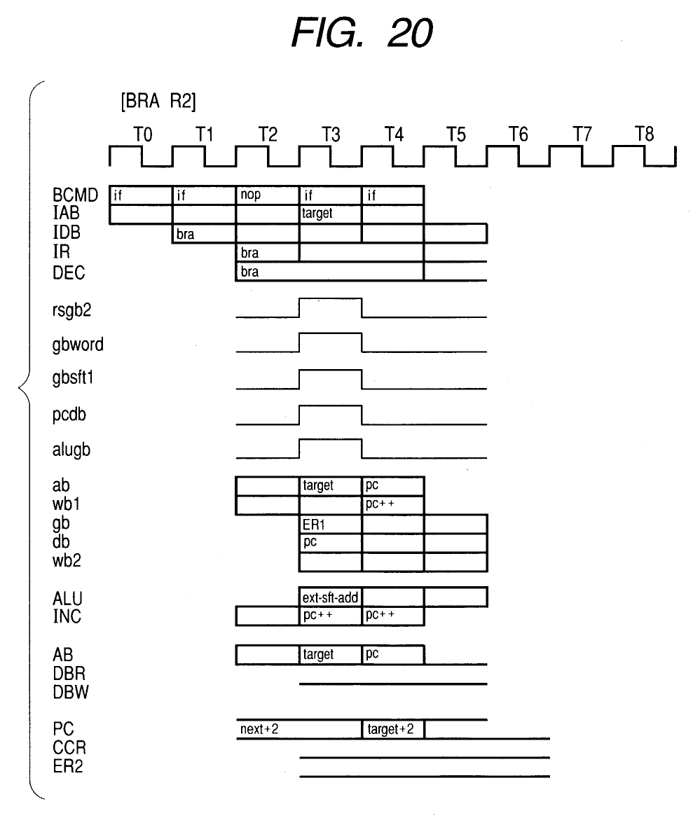

FIG. 20 shows an execution timing of the BRA R2 instruction. This execution timing is common to that of the instructions having the instruction format of the [branch instruction 1] shown in FIG. 11.

Similarly to the above case, the instruction code is inputted to the instruction decoder DEC at T2 so that the instruction is decoded there. Then, part (register specification field (r)) of the instruction code is output to the register selector RESL and decoded there. Then, according to the decoding result, the instruction reading is suppressed at T2. At T3, a control signal/register selection signal is output. The signal rsgb2 is then activated to output the value of the general-purpose register ER2 to the internal bus gb. In addition, the signal pcdb (indication signal for outputting the PC value to the bus db) is activated, thereby the value of the program counter PC is output to the internal bus db. All the above signals are inputted to the arithmetic and logic operation unit ALU. After that, the signals gbword and gbsft1 are activated to extend the lower 16 bits of the data inputted from the internal bus gb with zeroes, then shift the result by one bit and the shifted data is added to the data inputted from the internal bus db. The result is then output to the internal bus ab. The address (target) output to the internal bus ab is output to the internal address bus IAB through the address buffer AB. At the same time, a bus command BCMD that indicates instruction reading is output to the same bus IAB. The data output to the internal bus ab is increased by two in the incremental meter and stored in the program counter PC.

The instruction is read and the value in the program counter PC increases at T4 according to the updated value of the program counter PC. At T5, the branch destination instruction code read at T3 is inputted to the instruction decoder DEC so that the instruction is decoded there.

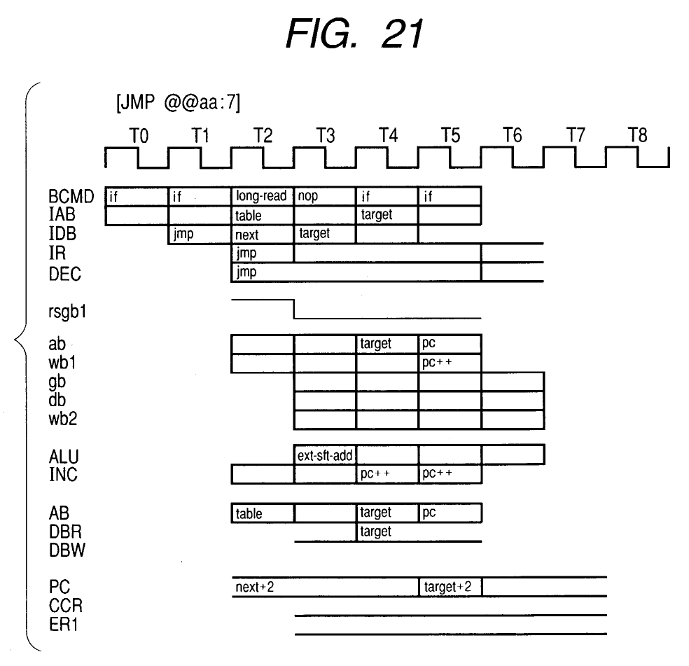

FIG. 21 shows an execution timing of the JMP @@aa: 7 instruction. This execution timing is common to that of the instructions having the instruction format of the instruction [branch instruction 2] shown in FIG. 11.

Similarly to the above case, the instruction code is inputted to the instruction decoder DEC at T2 so that the instruction is decoded there. According to the decoding result, the control signal aa7rd is activated. And, part (bits 6-0) of the instruction code is output to the address buffer AB, then a fixed value (H′80) and the value in the vector base register VBR are inputted to the upper bits of the address buffer AB at T2 respectively. According to the operation mode (mode) of the CPU, when the CPU is in the minimum operation mode, the data is shifted by one bit. When the CPU is in the maximum operation mode, the data is shifted by two bits and the result is output to the internal address bus IAB. In the minimum mode, a bus command BCMD that denotes word reading is output while in the maximum mode, a bus command BCMD that denotes long word reading is output at this time. At T3, the CPU stands by. For a subroutine branch instruction, a stack operation should be performed in this state.

The read data is stored in the read data buffer DBR at T4. The same data is also output to the internal address bus IAB through the internal bus ab and the address buffer AB respectively. At the same time, a bus command BCMD that denotes instruction reading is output to the same bus IAB. The data output to the internal bus ab is increased by two in the incremental meter INC, then stored in the program counter PC.

At T5, the instruction is read and the value in the program counter PC is increased according to the updated value of the program counter PC. At T6, the branch destination instruction code read at T3 is inputted to the instruction decoder DEC so that the instruction is decoded there.

At this time, the number of execution states can be set equally to that for reading the instruction code of a 32-bit absolute address branch instruction in units of 16 bits. If a 32-bit absolute address is already read, for example, by reading the instruction code in units of 32 bits before the 32-bit absolute address branch instruction is executed, the processing becomes faster than the processing in the extended memory indirect addressing mode. A processing for faster branching may thus use such a 32-bit absolute address branch instruction. For a plurality of branch instructions to be executed for the same destination, which do not require to be executed so faster, a branch instruction may be executed in the extended memory indirect addressing mode. This may be specified as a C compiler option or source program control instruction.

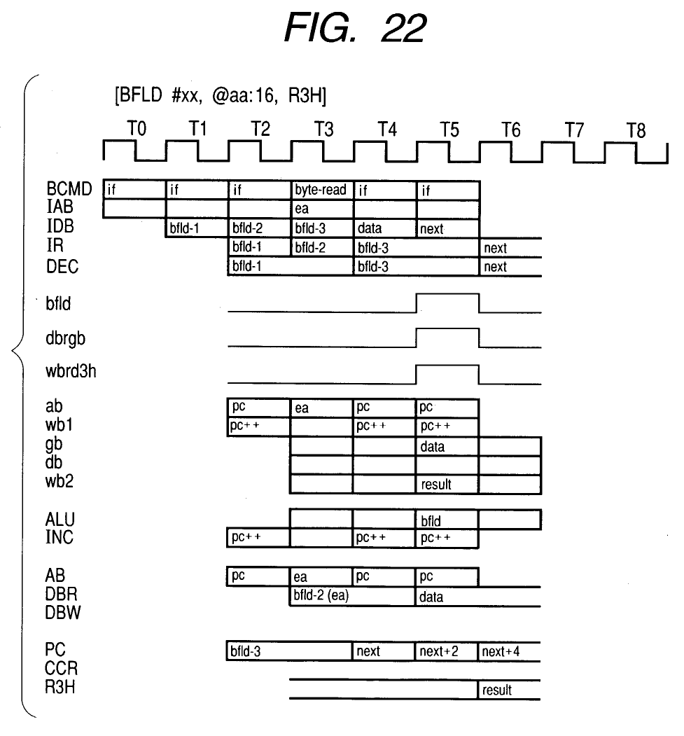

FIG. 22 shows an execution timing of the BFLD #xx, @aa: 16, R3H instruction. This execution timing is common to that of the instructions having the instruction format of the instruction [bit field instruction] shown in FIG. 11(5).

Similarly to the above case, the first word (bfld-1) of the instruction code is inputted to the instruction decoder DEC so that the instruction content is decoded there at T2. The second word absolute address (bfld-2) is inputted to the read data buffer DBR at T3. The third word (bfld-3) is inputted to the instruction decoder DEC at T4 so that the instruction content is decoded there.

According to the decoding result, the signals dbrab (indication signal for outputting the data in the buffer DBR to the bus ab) and dbrext (indication signal for extending the code of the information retained in the buffer DBR) are activated at T3 to extend the code of the lower 16 bits and the result is output to the internal address bus IAB through the internal bus ab and the address buffer AB respectively. At the same time, a bus command BCMD that denotes byte reading is output to the same bus IAB. Read data is inputted to the read data buffer DBR at T5.

At T5, a control signal/register selection signal is output. The signal dbrgb is activated to output read data to the internal bus gb and immediate data (imm) of a part of the instruction code is inputted to the arithmetic and logic operation unit ALU. Then, the signal bfld is activated, thereby the arithmetic and logic operation unit ALU calculates for loading the value in the bit field and outputs the result to the internal bus wb2. At the same time, the signal wbrd3h (indication signal for loading data from the bus wb2 to the general-purpose register R3H) is activated, thereby the data of the internal bus wb2 is stored in the general-purpose register (rd) R3H, which is a destination register. Although not limited specially, if the instruction is the BFLD, the value in the condition code register CCR is retained as is.

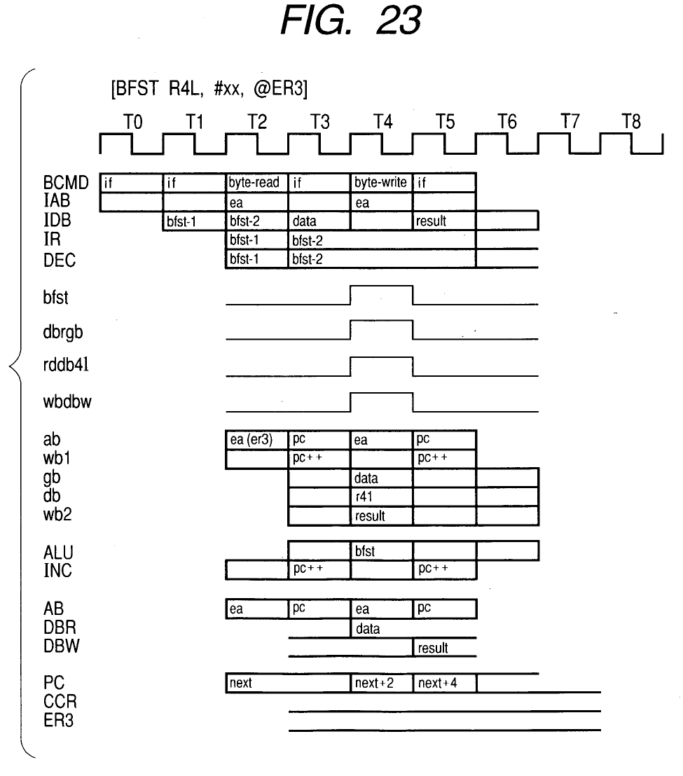

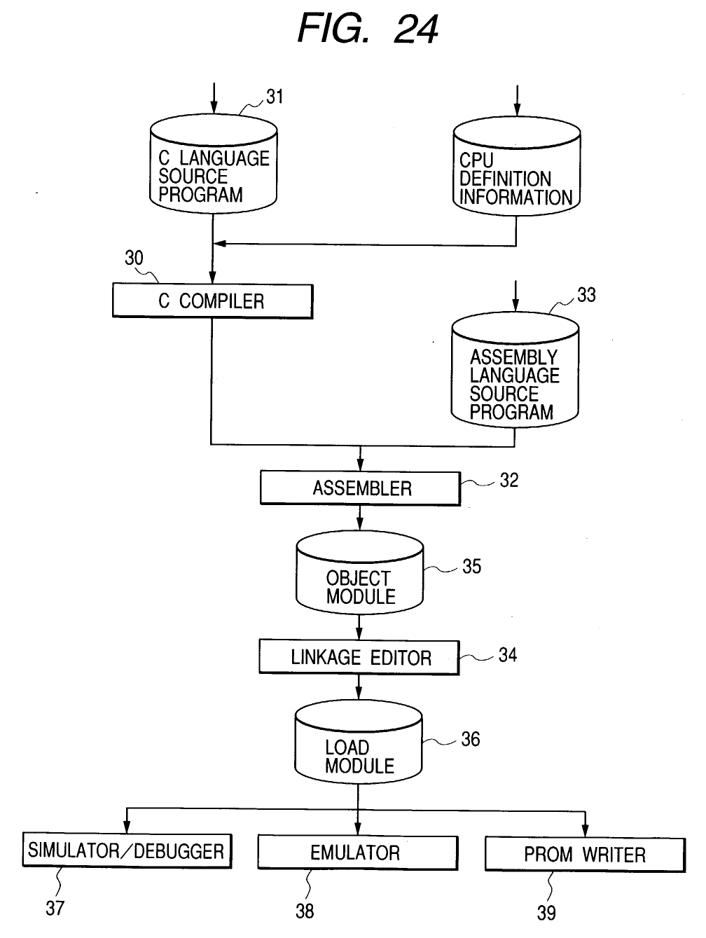

FIG. 23 shows an execution timing of the BFST R4L, #xx, @ER3 instruction. This execution timing differs from that of the signals shown in FIG. 22, which correspond to the instruction format of the [bit field instruction] shown in FIG. 11(6).

Similarly to the above case, the first word (bfst-1) of the instruction code is inputted to the instruction decoder DEC so that the instruction is decoded there at T2. At T3, the second word (bfst-2) of the instruction code is inputted to the instruction decoder DEC so that the instruction is decoded there. After that, according to the decoding result, the signal yrsab3 (not shown) is activated, thereby the data in the general-purpose register ER3 which is address register is output to the internal address bus IAB through the internal bus ab and the address buffer AB respectively. At the same time, a bus command BCMD that denotes byte reading is output to the same bus IAB. Read data is inputted to the read data buffer DBR at T4.

Then, a control signal/register selection signal is output at T4. The signal dbrgb is activated, thereby the read data is output to the internal bus gb. After that, the signal rddb41 is activated, thereby the data in the general-purpose register R4L which is source register is output to the internal bus db. Then, part (immediate data) of the instruction code is inputted to the arithmetic and logic operation unit ALU. After that, the signal bfst is activated, thereby the arithmetic and logic operation unit ALU makes a calculation so as to store the data in the bit field and outputs the calculation result to the internal bus wb2. At the same time, the signal wbdbw is activated, thereby the data in the internal bus wb2 is stored in the write data buffer DBW. The data in the internal bus wb2 is thus stored in the write data buffer DBR at T5. At that time, the same data as the data obtained at T2 is also output to the internal address bus IAB. The data may be retained in the temporary register TR at T2, then output to the internal bus ab at T4. The latter method is proposed in Japanese Unexamined Patent Publication No.2000-161137 separately. The data may also be retained in the address buffer AB. At T4, a bus command BCMD that denotes byte writing is output. At T5, the data in the write data buffer DBW is output to the internal data bus IDB. Although not limited specially, if the instruction is the BFST, the value in the condition code register CCR is retained as is.

FIG. 24 shows a schematic block diagram of the developing environment of the CPU 2. The developers often describe programs with the C or assembly language using various editors. A program is usually created as a plurality of modules.

A C compiler 30 receives each of C language source programs 31 created by programmers and outputs an assembly language source program or object module. The C compiler 30 also enables a function, etc. to be used for extended memory indirect addressing to be specified as an option at the time of compiling.

An assembler 32 receives assembly language source programs 33 and outputs an object module 35.

A linkage editor 34 receives a plurality of object modules 35 generated by the C compiler 30 and the assembler 32 to analyze the external reference, the relative address, etc. of each object module, link those object modules into one program, then output the program as a load module 36. At this time, the linkage editor 34 analyzes the program to decide the bit length of each of the displacement and the absolute address. The linkage editor 34 also assigns instructions having shorter instruction codes used for extended memory indirect addressing as branch instructions used for frequently branching. In short, this is to optimize the module linking.

The load module 36 can be inputted to a simulator/debugger 37 to simulate the operation of the CPU 2 in such a system developing apparatus as a personal computer, display the result, and analyze and evaluate the program. The load module 36 can also be inputted to an emulator 38 and operated in an actual application system, that is, to make an in-circuit emulation to analyze and evaluate the actual operation of the whole microcomputer. The load module 36 can also be inputted to a PROM writer 39 to load created programs into an external flash memory, for example, when the built-in ROM of the microcomputer is a flash memory. The format of the load module 36 may be converted to a desired one as needed with use of, for example, an object converter. In addition, general-purpose subroutines can be collected into a librarian to be provided.

According to the microcomputer described above, therefore, the following effects are obtained.

(1) Because the microcomputer is provided with a function for executing an instruction corresponding to a processing that have required a plurality of instructions conventionally, the easiness for operating the microcomputer is improved, the program capacity is reduced, and the processing speed is improved. And, because the program capacity is reduced such way, the memory capacity of such a ROM for storing programs is reduced and the manufacturing cost is reduced.

(2) Both index and data registers are allowed to handle data in the same unit. This makes it easier to create programs and use the upper-part of each general-purpose register as an additional data register.

(3) An instruction that calculates an effective address so as to use the data in a general-purpose register as an index register and store the result in the same general-purpose register comes to reduce the capacity of the register specification field (r) to be used while a general-purpose register used once is usually not to be used so frequently, it is possible to reduce the instruction code in length or enable another instruction code to be used additionally in the general-purpose register while the easiness to operate is kept as is.

(4) In each index register, data is lower-padded. As a result, the number of index registers and the number of address registers come to be equal. Thus, it is easy to use a common instruction format between index and address registers. This makes it easy to add index registers to any existing CPU.

(5) The extended memory indirect addressing mode enables a subroutine vector table to be mapped in an area adjacent to an exception processing vector table, thereby programming becomes easier. And, both exception processing vector table and subroutine vector table, when they are disposed not to lie one upon another, can be used more effectively. If the vector base register VBR is used for both exception processing and subroutine calling, resources can be used more effectively and the easiness to operate is more improved.

(6) Because a C compiler is used to select whether to use the extended memory indirect addressing mode, the program capacity can be reduced efficiently.

(7) Because immediate data is used to specify a bit field, the logic structure is simplified. The bit field operation block can be disposed in parallel to the arithmetic and logic operation block in which the calculation unit has a carrying function to equalize the delay time between the blocks, thereby suppressing the delay time.

(8) A dedicated subroutine vector base register TBR that points the start address table of subroutine calling is used separately from the exception processing vector base register VBR so as to improve the efficiency of coding, correspondence to the full address space within a jump-allowed range, and programming with use of a dedicated subroutine vector table area to be disposed freely. While the preferred embodiment of the present invention has been described, it is to be understood that modifications will be apparent to those skilled in the art without departing from the spirit of the invention.

For example, general-purpose registers are not required necessarily to be used for both address and data commonly; some or all the general-purpose registers may be dedicated to addresses or data and the data size of those general-purpose registers may be decided freely. And, while data is lower-padded in each index register, any of the general-registers RH and E may be used as such an index register.

The CPU instruction system and the instruction format of the present invention may be changed freely. For example, the MOVA instruction specifies the same general-purpose register both before and after an I/O processing in the present invention, the MOVA instruction may also specify another general-purpose register for storing data after an I/O processing or specify data in a memory as a source (index register). The index register with displacement indirect addressing mode may be used for the MOV instruction, as well as for other operation and calculation instructions to specify a memory. While the ALU is provided with both zero-extension and shifting functions used in the indirect addressing mode for index registers with displacement, the internal bus gb may also be provided with the same functions.

The vector base register VBR may be omitted. It is also possible to select whether to use the VBR according to the operation mode. The detailed logic and execution sequence for transferring bit field data may be changed. It is not necessarily required to have both of the addressing modes shown in (6a) and (6b) of FIG. 25; any one of them will do enough.

The basic unit of instruction codes is not necessarily limited only to 16 bits; any bit width, for example, 8 bits or 32 bits, may be employed. Branch instructions in the extended memory indirect addressing mode are just required to be shorter in instruction code than branch instructions that use absolute addresses. While the bit width is decided as 32 bits and each instruction is read in 16 bits so as to simplify the description in this document, each instruction may be read in 32 bits to make the reading faster. This method is disclosed in Japanese Unexamined Patent Publication No.Hei11(1999)-167812. The bus width may be 16 bits and reading/writing by long words may be executed twice by words.

The number of bits in the program counter, as well as the configuration of the control register may be changed freely. The VBR register in the CPU may also be used as an internal I/O register. The number of bits in the VBR may also be changed freely. The VBR value may also be switched to a fixed value according to the operation mode or the value in the subject internal I/O register.

While a description has been made for an application of the present invention to a single chip microcomputer, the present invention may also apply widely to any of other data processing apparatuses such as system-on-chip microcomputers, data processors, and general-purpose microprocessors. The present invention can apply to any data processor that decodes and processes instructions to calculate object data.

The effect obtained by the typical item of the present invention disclosed in this document will be summarized as follows.

Because the data processor of the present invention is provided with a function for executing an instruction corresponding to the processing that has conventionally been executed with use of a plurality of instructions, the easiness for operating the data processor is improved, the program capacity is reduced, and the processing speed is improved. And, because the program capacity is reduced such way, the capacity of such a memory as a ROM for storing programs is reduced and the manufacturing cost is reduced.

What is claimed is:

1. A data processor, including:
a instruction executing circuit for reading and decoding an instruction, then executing said instruction according to the result of said decoding;
wherein said instruction executing circuit includes a general-purpose register including a storage area usable for storing information wholly or partially; and when having read a first instruction that uses said storage area of said general-purpose register partially, said instruction executing circuit shifts information stored in said general-purpose register specified by said first instruction according to an access size of said information, then adds different information to said shifted information so as to obtain an effective address.

2. The data processor according to claim 1,
wherein said instruction executing circuit, when having read a second instruction that uses said storage area of said general-purpose register wholly, adds different information to said information stored in said general-purpose register specified by said second instruction without shifting said information to obtain an effective address.

3. The data processor according to claim 1,
wherein said different information is included in said first instruction, which is a transfer instruction.

4. The data processor according to claim 3,
wherein information included in said first instruction is reference address information.

5. The data processor according to claim 1,
wherein said different information is instruction address information included in program counting circuit and said first instruction is a branch instruction.

6. The data processor according to claim 1,
wherein said instruction executing circuit, when having read a third instruction that uses a part of said storage area of said general-purpose register, shifts said information according to an access size of said information, adds different information to said shifted information to obtain an effective address, and stores said obtained effective address in a different general-purpose register.

7. The data processor according to claim 2,
wherein said instruction executing circuit, when having read said third instruction that uses a part of said storage area of said general-purpose register, shifts information according to an access size of said information, adds different information to said shifted information to obtain an effective address, and store said obtained effective address in a different general-purpose register.

8. A data processor, including:
a decoding circuit which decodes an instruction; and
a calculating circuit which calculates object data according to the result of said decoding by said decoding circuit;
wherein said decoding circuit decodes a predetermined instruction and outputs control information which includes selection of a general-purpose register, an information access size, and the number of shifting bits; and
wherein said calculating circuit includes a general-purpose register and a calculator coupled to said general-purpose register and is used for zero-extension for the logic value “0” with respect to the upper bits of said general-purpose register selected by said control signal, shifting said zero-extended data by the number of bits corresponding to said access size, and adding different information to said shifted data.

9. The data processor according to claim 8,
wherein said different information is reference address information included in said instruction.

10. The data processor according to claim 8,
wherein said calculation circuit calculates only the data specified by an access size of said information selected from the data stored in said general-purpose register.

11. A data processor, including:
a instruction executing circuit which reads and decodes an instruction, then executes said instruction according to the result of said decoding;
wherein said instruction executing circuit is able to unite an offset value with the value in a predetermined field of said instruction, then shift said information by the number of bits according to an access size of said information, add different information to said shifted information to obtain an effective address, read a memory according to said obtained effective address, and execute a branch instruction according to said read information, which is assumed as an address for said branching.

12. The data processor according to claim 11,
wherein said predetermined field is a vector number field.

13. The data processor according to claim 12,
wherein said offset value is information other than 0 that prescribes the upper part of the value set in said predetermined field.

14. The data processor according to claim 13,
wherein said different information is retained in a vector base register included in said instruction executing circuit.

15. The data processor according to claim 14,
wherein said offset value is a value that enables an access to a different table other than an exception processing vector table.

16. The data processor according to claim 14,
wherein said different information is retained in a predetermined register included in said instruction executing circuit.

17. A data processor, including:
a instruction executing circuit which reads and decodes an instruction, then executes said instruction according to the result of said decoding;
wherein said instruction executing circuit includes a vector base register usable for referring to an exception processing vector table and a first register usable for referring to a subroutine vector table;
wherein said instruction executing circuit is able to shift the value in a predetermined field of an instruction by the number of bits according to an access size of information, add a value set in said first register to said shifted value to obtain an address, read said subroutine vector table according to said obtained address, and execute a subroutine call instruction according to said read data, which is assumed as a branch destination subroutine address.

18. A data processor, including:
a instruction executing circuit which reads and decodes an instruction, then executes said instruction according to the result of said decoding;
wherein said instruction executing circuit includes a vector base register usable for referring to an exception processing vector table, as well as first and second registers usable for branching to a subroutine respectively;
wherein said instruction executing circuit can shift the value in a predetermined field of an instruction by the number of bits according to an access size of information, add the value in said first register to said shifted value to obtain an address, read a subroutine vector table according to said obtained address, and add the value in said second register to said read data to obtain a branch destination subroutine address, and execute a subroutine call instruction according to the obtained subroutine call address.

19. A data processor, including:
a instruction executing circuit which reads and decodes an instruction, then executes said instruction according to the result of said decoding,
wherein said instruction executing circuit can read data from a memory and operate logic operation AND said read data and information included in the subject instruction code, then right-shift the result of said logic operation AND so that the first state lower bit of said information becomes the least significant bit, thereby executing a load instruction for storing the result of said right-shifting in a general-purpose register.

20. A data processor, including:
a instruction executing circuit for reading and decoding an instruction, then executing said instruction according to the result of said decoding,
wherein said instruction executing circuit can read data from a memory, left-shift the value in a general-purpose register up to a first state lower bit of information included in a subject instruction code; said first state lower bit of said information selects said shifted value; and a second state bit selects said data read from said memory, thereby said instruction executing circuit can execute a store instruction for storing said selected data in said memory respectively.

21. The data processor according to claim 19,
wherein said instruction code includes information used to specify an address in said memory and information used to specify a general-purpose register.

22. The data processor according to claim 20,
wherein said instruction code includes information used to specify an address in a memory and information used to specify a general-purpose register.

23. The data processor according to claim 1,
wherein said instruction executing circuit is a central processing unit formed on one semiconductor substrate.

24. The data processor according to claim 11,
wherein said instruction executing circuit is a central processing unit formed on one semiconductor substrate.

25. The data processor according to claim 17,
wherein said instruction executing circuit is a central processing unit formed on one semiconductor substrate.

26. The data processor according to claim 19,
wherein said instruction executing circuit is a central processing unit formed on one semiconductor substrate.

27. The data processor according to claim 20,
wherein said instruction executing circuit is a central processing unit formed on one semiconductor substrate.
